(19) United States
(12) Patent Application Publication
(10) Pub. No.: US 2026/0039839 A1
(43) Pub. Date: Feb. 5, 2026

(54) ENCODING/DECODING METHOD AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(73) Assignee: GUANGDONG OPPO MOBILE TELECOMMUNICATIONS CORP., LTD., Dongguan (CN)

(21) Appl. No.: 19/359,434

(22) Filed: Oct. 15, 2025

Related U.S. Application Data
(63) Continuation of application No. PCT/CN2023/088805, filed on Apr. 17, 2023.

(51) Int. Cl. H04N 19/167; H04N 19/103; H04N 19/196; H04N 19/33; H04N 19/597

(52) U.S. Cl. CPC H04N 19/167; H04N 19/103; H04N 19/196; H04N 19/33; H04N 19/597

(57) ABSTRACT

Embodiments of the present application provide an encoding/decoding method and a non-transitory computer-readable storage medium, including: an encoder/decoder determining a first node quantity of nodes of a current layer and a second node quantity of child nodes corresponding to the nodes of the current layer, wherein the first node quantity and the second node quantity are used for determining whether to perform RAHT on the nodes of the current layer; and, according to the first node quantity and the second node quantity, determining attribute reconstruction values of the child nodes corresponding to the nodes of the current layer.

### CROSS-REFERENCE TO RELATED APPLICATION

The present application is a continuation of International Application No. PCT/CN2023/088805 filed on Apr. 17, 2023, the disclosure of which is hereby incorporated by reference in its entirety.

### BACKGROUND

In a Geometry-based Point Cloud Compression (G-PCC) codec framework or a Video-based Point Cloud Compression (V-PCC) codec framework provided by the Moving Picture Experts Group (MPEG), geometric information and attribute information of a point cloud are separately encoded.

At present, attribute information coding is mainly coding of color information. In the coding of the color information, there are two main transform methods. One is distance-based lifting transform that relies on Level of Detail (LOD) division, and the other is direct Region Adaptive Hierarchal Transform (RAHT).

However, when performing RAHT, nodes of each level need to be transformed, predicted, coded/decoded sequentially, which will increase the complexity of RAHT attribute transform encoding and decoding, and then the redundancy of attributes cannot be effectively removed, resulting in low attribute coding efficiency.

### SUMMARY

Embodiments of the present application relate to the technical field of point cloud compression.

Embodiments of the present application provide an encoding method, a decoding method and a storage medium.

The technical solution of the embodiments of the present application can be realized as follows:

According to a first aspect, an embodiment of the present application provides a decoding method applied to a decoder, the method includes the following operations. A first node number of nodes of a current level and a second node number of child nodes corresponding to the nodes of the current level are determined. The first node number and the second node number are used to determine whether to perform RAHT on the nodes of the current level

Reconstructed attribute values of the child nodes corresponding to the nodes of the current level are determined according to the first node number and the second node number.

According to a second aspect, an embodiment of the present application provides an encoding method applied to an encoder, the method includes the following operations.

A first node number of nodes of a current level and a second node number of child nodes corresponding to the nodes of the current level are determined. The first node number and the second node number are used to determine whether to perform RAHT on the nodes of the current level.

Reconstructed attribute values of the child nodes corresponding to the nodes of the current level are determined according to the first node number and the second node number.

According to a third aspect, an embodiment of the present application provides a computer-readable storage medium having a computer program and a bitstream stored thereon, the computer program, when executed by a processor, enables the processor to perform the method according to the second aspect to generate the bitstream.

### BRIEF DESCRIPTION OF THE DRAWINGS

FIG. 1A is a schematic diagram of a three-dimensional point cloud picture;

FIG. 1B is a partial enlarged view of a three-dimensional point cloud picture;

FIG. 2A is a schematic view of six viewing angles for a point cloud picture;

FIG. 2B is a schematic diagram of a data storage format corresponding to a point cloud picture;

FIG. 3 is a schematic diagram of a network architecture for point cloud encoding and decoding;

FIG. 4A is a schematic diagram of a configuration framework of a G-PCC encoder;

FIG. 4B is a schematic diagram of a configuration framework of a G-PCC decoder;

FIG. 5A is a schematic diagram of a low plane position in the Z-axis direction;

FIG. 5B is a schematic view of a high plane position in the Z-axis direction;

FIG. 6 is a schematic diagram of a node encoding sequence;

FIG. 7A is a schematic diagram of a planar identification information;

FIG. 7B is another schematic diagram of planar identification information;

FIG. 8 is a schematic diagram of a sibling node of a current node;

FIG. 9 is a schematic diagram of intersection between a lidar and nodes;

FIG. 10 is a schematic diagram of neighborhood nodes at a same partition depth and having same coordinates as a current node;

FIG. 11 is a schematic diagram of a current node being located at a lower plane position of a parent node;

FIG. 12 is a schematic diagram of a current node being located at an upper plane position of a parent node;

FIG. 13 is a schematic diagram of predictive coding for plane position information of a lidar point cloud;

FIG. 14 is a schematic diagram of an Infer Direct Coding Mode (IDCM) encoding;

FIG. 15 is a schematic diagram of coordinate transform for a point cloud obtained by a rotating lidar;

FIG. 16 is a schematic diagram of predictive encoding in X-axis or Y-axis;

FIG. 17A is a schematic diagram of predicting an angle in Y-plane based on horizontal azimuth;

FIG. 17B is a schematic diagram of predicting an angle in the X-plane based on horizontal azimuth;

FIG. 18 is a schematic diagram of another predictive encoding in X-axis or Y-axis;

FIG. 19A is a schematic diagram of three intersection points included in a sub-block;

FIG. 19B is a schematic diagram of a triangular patch set fitted using three intersection points;

FIG. 19C is an diagram of upsampling of a triangular patch set;

FIG. 20 is a schematic diagram of a distance-based LOD construction process;

FIG. 21 is a schematic diagram of a visualization result of a LOD generation process;

FIG. 22 is a schematic diagram of an encoding flow for an attribute prediction;

FIG. 23 is a schematic diagram of the composition of a pyramid structure;

FIG. 24 is a schematic diagram of the composition of another pyramid structure;

FIG. 25 is a schematic diagram of an LOD structure for inter-level nearest neighbor search;

FIG. 26 is a schematic structural diagram of a nearest neighbor search based on a spatial relationship;

FIG. 27A is a schematic representation of a coplanar spatial relationship;

FIG. 27B is a schematic diagram of a coplanar or collinear spatial relationship;

FIG. 27C is a schematic diagram of a coplanar, collinear or co-point spatial relationship;

FIG. 28 is a schematic diagram of an inter-level prediction based on fast search;

FIG. 29 is a schematic structural diagram of LODs for nearest neighbor search in an attribute level;

FIG. 30 is a schematic diagram of an intra-level prediction based on fast search;

FIG. 31 is a schematic structural diagram of block-based neighborhood search;

FIG. 32 is a schematic diagram of an encoding flow for a lifting transform;

FIG. 33 is a schematic structural diagram for RAHT;

FIG. 34 is a schematic diagram of a transform process of a RAHT along x, y and z directions;

FIG. 35A is a schematic diagram of a process of a RAHT positive transform;

FIG. 35B is a schematic diagram of a process of an inverse RAHT;

FIG. 36 is a schematic structural diagram of an attribute coding block;

FIG. 37 is an overall flowchart of a RAHT attribute prediction and transform encoding;

FIG. 38 is a schematic relationship diagram of a neighborhood prediction for a current block;

FIG. 39 is a schematic diagram of a calculation process of an attribute transformation coefficient;

FIG. 40 is a schematic structural diagram of a RAHT attribute inter-predictive coding;

FIG. 41 is a schematic flowchart of a decoding method according to an embodiment of the present application.

FIG. 42 is a schematic flowchart of an encoding method according to an embodiment of the present application;

FIG. 43 is a schematic diagram of a configuration structure of an encoder according to an embodiment of the present application.

FIG. 44 is a schematic diagram of a specific hardware structure of an encoder according to an embodiment of the present application.

FIG. 45 is a schematic diagram of a configuration structure of a decoder according to an embodiment of the present application.

FIG. 46 is a schematic diagram of a specific hardware structure of a decoder according to an embodiment of the present application;

FIG. 47 is a schematic diagram of a configuration structure of a codec system according to an embodiment of the present application.

### DETAILED DESCRIPTION

In order to enable a more detailed understanding of features and technical contents of embodiments of the present disclosure, implementations of the embodiments of the present disclosure will be described in detail below in conjunction with accompanying drawings, which are provided for illustration only and are not intended to limit the embodiments of the present disclosure.

Unless otherwise defined, all technical and scientific terms used herein have the same meaning as commonly understood by those skilled in the technical field of the present disclosure. The terms used herein is only for the purpose of describing the present disclosure, and is not intended to limit the present disclosure.

In the following description, “some embodiments” describe a subset of all possible embodiments, but it is to be understood that “some embodiments” may be the same subset or different subsets of all possible embodiments, and may be combined with each other without conflict.

It is to be noted that the term “first\ second\ third” involved in the embodiments of the present disclosure is used for distinguishing similar objects and does not represents a specific sequence for a specific object. It is to be understood that the term “first\ second\ third” may be interchangeable under an appropriate circumstance, so that the embodiments of the present disclosure described herein may be implemented in an order other than those illustrated or described herein.

A point cloud is a three-dimensional representation for a surface of an object. The point cloud (data) on the surface of the object may be acquired through acquisition devices, such as, a photoelectric radar, a lidar, a laser scanner, multi-view camera, or the like.

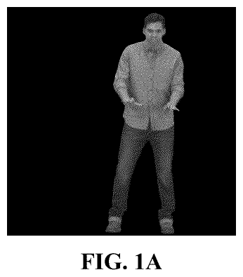

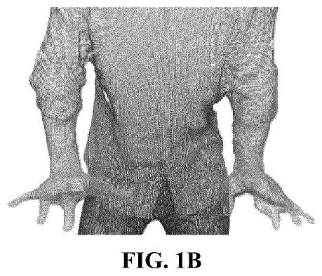

A point cloud is a set of discrete points irregularly distributed in the space and representing spatial structure and surface attributes of a three-dimensional object or scene. FIG. 1A shows a three-dimensional point cloud picture and FIG. 1B shows a partial enlarged view of the three-dimensional point cloud picture. As can be seen that the surface of the point cloud is composed of densely distributed points.

For a Two-Dimensional (2D) picture, there is information presentation at each pixel and pixels are regularly distributed, so it is not necessary to additionally record position information of each pixel. However, the distribution of points in a point cloud in three-dimensional space is random and irregular, so it is necessary to record a position of each point in the space, so as to completely express the point cloud. Similar to a two-dimensional picture, in an acquisition process, each position has corresponding attribute information that usually is a RGB color value reflecting a color of an object. For a point cloud, in addition to the color information, the attribute information corresponding to each point commonly includes a reflectance value that reflects a surface material of the object. Therefore, point cloud data usually includes: geometric information including three-dimensional position information, and attribute information including three-dimensional color information and one-dimensional reflectance information. A point in the point cloud may include position information of the point and attribute information of the point. For example, the position information of the point may be three-dimensional coordinate information (x, y, z) of the point. The position information of the point may also be referred to as the geometric information of the point. For example, the attribute information of the point may include color information (three-dimensional color information) and/or a reflectance (one-dimensional reflectance information r), and the like. For example, the color information may be any kind of information in a color space. For example, the color information may be RGB information. Here, R represents Red (R), G represents Green (G), and B represents Blue (B). For another example, the color information may be represented as luma-chroma information (YCbCr, YUV). Here, Y represents luma, Cb (U) represents blue chroma, and Cr (V) represents red chroma.

For a point cloud obtained according to a principle of a laser measurement, each point in the point cloud may include three-dimensional coordinate information of the point and a reflectance value of the point. For another example, for a point cloud obtained according to a principle of photogrammetry, each point in the point cloud may include three-dimensional coordinate information of the point and three-dimensional color information of the point. For yet another example, for a point cloud obtained by combining the principles of Laser measurement and the photogrammetry, each point in the point cloud may include three-dimensional coordinate information of the point, a reflectance value of the point, and three-dimensional color information of the point.

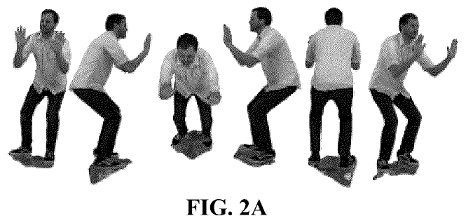

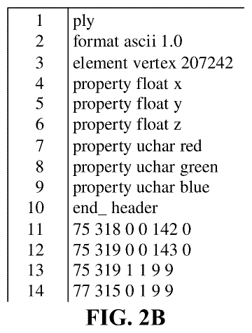

FIG. 2A and FIG. 2B show a point cloud picture and a data storage format corresponding to the point cloud picture. Here, FIG. 2A provides six viewing angles for the point cloud picture, and FIG. 2B includes a file header information section and a data section. The header information includes a data format, a data representation type, a total number of points in the point cloud, and the content represented by the point cloud. For example, the point cloud is in a “ply” format, represented by ASCII code, with a total number of points being 207242, and each point has three-dimensional coordinate information (x, y, z) and three-dimensional color information (r, g, b).

According to the way for obtaining point clouds, the point clouds may be categorized as: a static point cloud, a dynamic point cloud, and dynamically captured point cloud.

For the static point cloud, an object is stationary, and a device for capturing the point cloud is also stationary.

For the dynamic point cloud, an object is in motion, but a device for capturing the point cloud is stationary.

For the dynamically captured point cloud, a device for capturing the point cloud is in motion.

For example, according to usage of point clouds, the point clouds are categorized as two categories.

Category 1 is a machine-perception point cloud which may be used in scenarios, such as autonomous navigation systems, real-time inspection systems, geographic information systems, visual sorting robots, emergency rescue, disaster relief robots, etc.

Category 2 is a human eye-perception point cloud which may be used in point cloud application scenarios, such as digital cultural heritage, free viewpoint broadcasting, three-dimensional immersive communication, three-dimensional immersive interaction, etc.

A point cloud can flexibly and conveniently express the spatial structure and surface attributes of a three-dimensional object or scene; and since the point cloud may be obtained by directly sampling a real object, it is possible to provide a strong sense of realism on the premise of ensuring accuracy. Therefore, the point cloud is used in a wide range of applications, including virtual reality gaming, computer-assistance design, geographic information systems, automatic navigation systems, digital cultural heritage, free viewpoint broadcasting, three-dimensional immersive telepresence, three-dimensional reconstruction of biological tissues and organs, etc.

Point cloud capture is primarily accomplished through below approaches: computer generation, 3D laser scanning, 3D photogrammetry, etc. A computer can generate a point cloud of a virtual three-dimensional object and scene. 3D laser scanning can capture a point cloud of a three-dimensional object or scene in the static real world with a speed of millions of points per second. 3D photogrammetry can capture a point cloud of a three-dimensional object or scene in the dynamic real world, yielding tens of ten millions of points per second. These technologies reduce the cost and time period of obtaining point cloud data, and improve the accuracy of data. The evolution of acquisition manners of point cloud data makes it possible to obtain a large amount of point cloud data. However, with a growth of demands of applications, processing such massive 3D point cloud data is limited by storage capacity and transmission bandwidth.

Exemplarily, taking a point cloud video with a frame rate of 30 fps (frames per second) as an example, the number of points in each frame of a point cloud is 700,000, and each point has coordinate information xyz (float) and color information RGB (uchar). The data amount of a 10 seconds (10 s) point cloud video is about 0.7 million× (4 Bytex3+1 Byte×3)×30 fps×10 s=3.15 GB, where 1 Byte is equal to 10 bits. However, for a 2D video with a resolution of 1280×720 having a YUV sampling format of 4:2:0 and a frame rate of 24 fps, the data amount of such 10s 2D video is about 1280×720×12 bit×24 fps×10s˜0.33 GB. In this case, the data amount of a 10s two-view 3D video is about 0.33×2-0.66 GB. As can be seen that, the data amount of a point cloud video far exceeds the data amount of a two-dimensional video and a three-dimensional video in a same time priod. Therefore, in order to better realize data management, save the storage space of a server, and reduce transmission traffic and transmission time between a server and a client, point cloud compression has become a key to promote the development of point cloud industry.

That is to say, since a point cloud is a set of massive points, storing the point cloud not only consumes a large amount of memory, but also is not conducive to transmission, and there is no such large bandwidth to support the direct transmission of the point cloud in the network level without compression, so it is necessary to compress the point cloud.

At present, a point cloud encoding framework that may be used to compress a point cloud may be a Geometry-based Point Cloud Compression (G-PCC) codec framework or a Video Point Cloud Compression (V-PCC) codec framework provided by the Moving Picture Experts Group (MPEG), or may also be an Audio Video Standard (AVS)-PCC codec framework provided by the AVS. The G-PCC codec framework may be used for performing compression on the first category of static point cloud and the third category of dynamically captured point cloud, and may be based on a point cloud compression test platform (Test Model Compression 13, TMC13). The V-PCC codec framework may be used for performing compression on the second category of dynamic point cloud and may be a point cloud compression test platform (Test Model Compression 2, TMC2). The G-PCC codec framework is also referred to as a point cloud codec TMC13, and the V-PCC codec framework is also referred to as a point cloud codec TMC2.

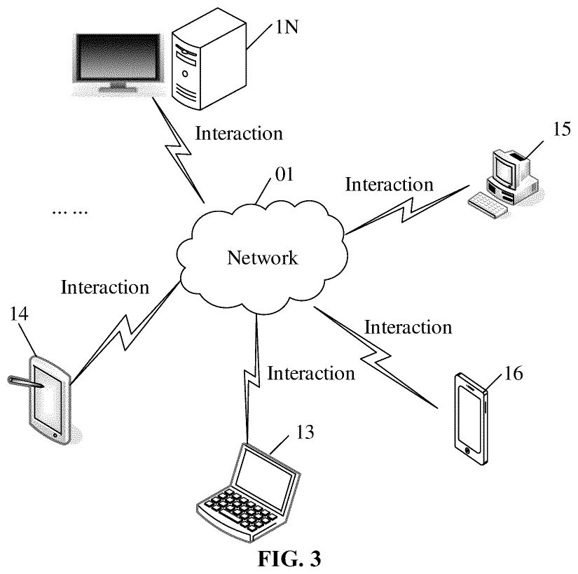

The embodiments of the present disclosure provide a network architecture of a point cloud codec system including a decoding method and an encoding method. FIG. 3 is a schematic diagram of a network architecture for point cloud encoding and decoding according to the embodiments of the present disclosure. As shown in FIG. 3, the network architecture includes one or more electronic devices 13 to 1N and a communication network 01. The electronic devices 13 to 1N may perform video interaction with each other through the communication network 01. In the process of implementation, the electronic devices may be various types of devices having point cloud encoding and decoding functions. For example, the electronic devices may include a phone, a tablet computer, a personal computer, a personal digital assistant, a navigator, a digital phone, a video phone, a television, a sensing device, a server, and the like, which is not limited in the embodiments of the present disclosure. Here, the decoder or the encoder described in the embodiments of the present disclosure may be the aforementioned electronic devices.

Here, the electronic devices in the embodiments of the present disclosure have functions of point cloud encoding and decoding, and generally include a point cloud encoder (i.e., an encoder) and a point cloud decoder (i.e., a decoder).

The G-PCC codec framework is taken as an example to explain the point cloud compression technology.

It is to be understood that in the point cloud G-PCC codec framework, the point cloud data to be encoded is firstly partitioned into multiple slices by slice partitioning. In each slice, the geometric information of a point cloud and the attribute information corresponding to each point cloud are encoded separately.

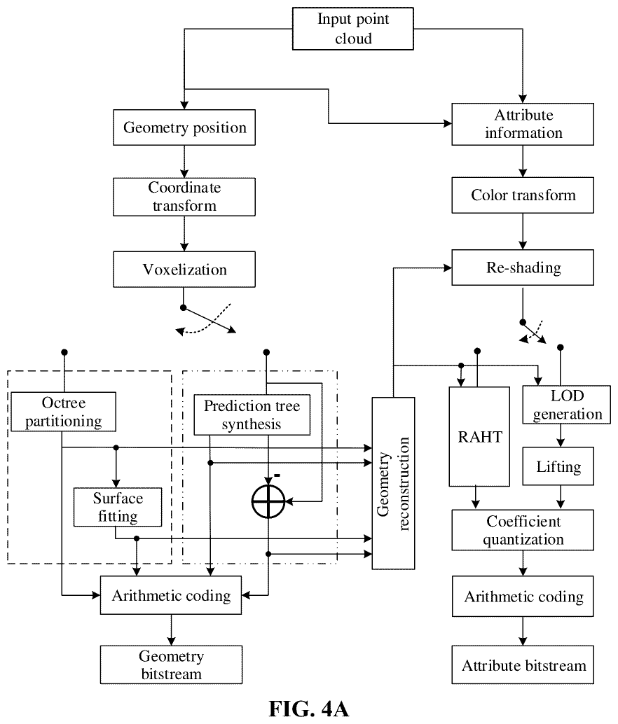

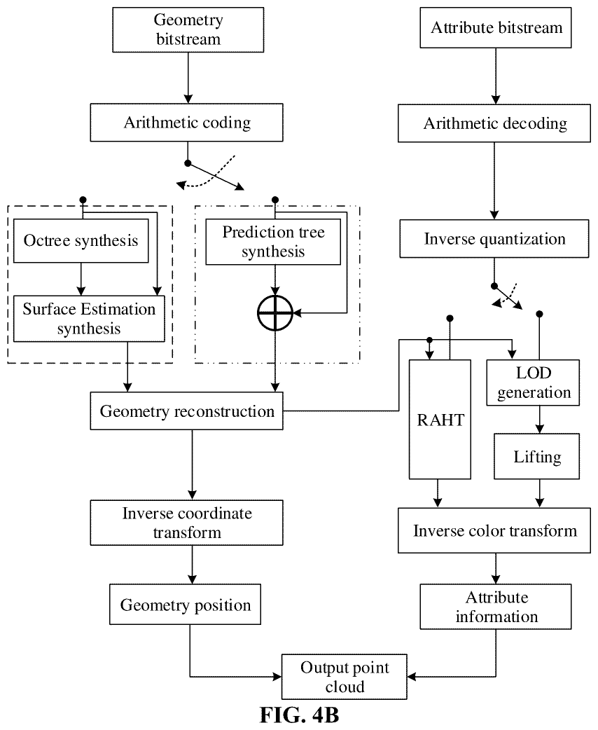

FIG. 4A a schematic diagram of a configuration framework of a G-PCC encoder. As shown in FIG. 4A, in a process of geometric encoding, coordinate transform is performed on geometric information, so that a point cloud is completely contained in a bounding box, and then quantization is performed. The quantization mainly plays a role of scaling. Since the quantization and rounding causes geometric information of a part of the point cloud to be identical, it is then determined, based on parameters, whether to remove duplicate points. The process of quantization and removing duplicate points is also called a voxelization process. Then octree partitioning or Prediction tree construction is performed on the bounding box. In this process, arithmetic encoding is performed on points in partitioned leaf nodes to generate a binary geometry bitstream, or arithmetic encoding is performed on partitioned vertexes (i.e., a surface fitting is performed based on vertexes) to generate a binary geometry bitstream. In the process of attribute encoding, after geometric encoding is completed and geometric information is reconstructed, color transform is performed, and color information (i.e., attribute information) is transformed from the RGB color space to the YUV color space. Then, the point cloud is re-shaded using the reconstructed geometric information, so that un-encoded attribute information corresponds to the reconstructed geometric information. The attribute encoding is mainly performed for color information. In the process of color information encoding, two transform methods exist: one is a distance-based lifting transform depending on LOD partitioning, and another is a directly performed Region Adaptive Hierarchical Transform (RAHT). In both two methods, color information will be transformed from a spatial domain to a frequency domain, high-frequency coefficients and low-frequency coefficients will be obtained through the transform, and then the coefficients are quantized. Finally, the arithmetic encoding is performed on quantized coefficients to generate a binary attribute bitstream.

FIG. 4B shows a schematic diagram of a configuration framework of a G-PCC decoder. As shown in FIG. 4B, for the obtained binary bitstream, firstly, the geometry bitstream and the attribute bitstream in the binary bitstream are decoded separately. When the geometry bitstream is decoded, the geometric information of the point cloud is obtained by arithmetic decoding-Synthesize Octree/Synthesize prediction tree-geometry reconstruction-inverse transform coordinate. When the attribute bitstream is decoded, the attribute information of the point cloud is obtained by arithmetic decoding-inverse quantization-LOD partitioning/RAHT-inverse transform color. The point cloud data to be encoded is restored based on the geometric information and the attribute information.

It is to be noted that, as shown in FIG. 4A or FIG. 4B, current G-PCC geometric codec may be classified into: octree geometric codec (identified by a dashed line box), and prediction tree geometric codec (identified by a dotted line box).

For the octree geometric encoding (denoted as OctGeomEnc), the OctGeomEnc includes: firstly coordinate transform is performed on geometric information so that all point clouds are included in one bounding box; then, quantization is performed, which is mainly for scaling; since the quantization and rounding causes geometric information of a part of the points to be identical, it is then determined, according to parameters, whether to remove duplicate points, where in the process of quantization and removing duplicate points is also called voxelization; next, tree partitioning (such as octree, quadtree, binary tree, etc.) is performed continuously on the bounding box in a breadth-first traversal order, and the occupancy code for each node is encoded. In the related art, a company proposes an implicit geometric partitioning method, including that: firstly, the bounding box (2^{d}^{ₓ}, 2^{d}^{_{y}}, 2^{d}^{_{z}}) of a point cloud is calculated, and it is assumed that dₓ>d_{y}>d_{z}, the bounding box is a cuboid; when geometric partitioning is performed, firstly, binary tree partitioning is performed continuously based on the x-axis to obtain two child nodes until the following condition is satisfied: dₓ=d_{y}>d_{z}, then quadtree partitioning is performed continuously based on the x-axis and y-axis to obtain four child nodes until the following condition is finally satisfied: dₓ=d_{y}=d_{z}, and then octree partitioning is performed continuously until the leaf nodes obtained by partitioning are unit cubes each with a size of 1×1×1; and encoding is performed on points in the leaf nodes to generate a binary bitstream. In the process of binary tree/quadtree/octree partitioning, two parameters: K and M are introduced. The parameter K indicates the maximum number of times of binary tree/quadtree partitioning allowed before octree partitioning; and the parameter M is used to indicate a side length of a minimum block corresponding to the binary tree/quadtree partitioning. K and M are required to satisfy the following condition: assuming dₘₐₓ=max(dₓ,d_{y}, d_{z}), dₘᵢₙ=min(dₓ, d_{y}, d_{z}) the parameter K satisfies: K>=dₘₐₓ−dₘᵢₙ, and the parameter M satisfies: M>dₘᵢₙ. The reason why the parameters K and M satisfy the above condition is that in the current process of implicit geometric partitioning of G-PCC, the priority order of partitioning is: binary tree, quadtree and octree. When a block size of a node does not satisfy the condition of the binary tree/quadtree, octree partitioning is performed continuously on the node until the leaf node has the minimum unit of 1×1×1. The octree geometric information-based encoding mode can effectively encode the geometric information of the point cloud by using the correlation between adjacent points in the space, but for some flat nodes or nodes with plane characteristics, the encoding efficiency for the geometric information of the point cloud can be further improved by using the planar encoding mode.

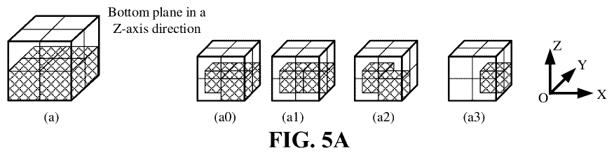

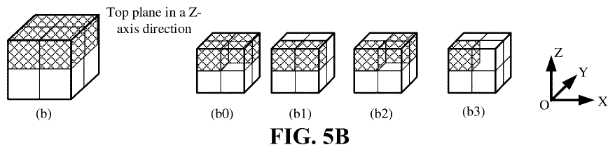

Exemplarily, FIG. 5A and FIG. 5B provide schematic diagrams of plane positions. FIG. 5A shows a schematic diagram of lower plane positions in the Z-axis direction. FIG. 5B shows a schematic diagram of a upper plane position in the Z-axis direction. As shown in FIG. 5A, (a), (a0), (a1), (a2), and (a3) all belong to the lower plane position in the Z-axis direction. (a) is taken as an example, it can be seen that the occupied four child nodes in the current node are all located at the lower plane positions of the current node in the Z-axis direction. Therefore, it can be considered that the current node belongs to a Z plane and is a lower plane in the Z-axis direction. Similarly, as shown in FIG. 5B, (b), (b0), (b1), (b2), and (b3) all belong to a upper plane position in the Z-axis direction. (b) is taken as an example, it can be seen that the occupied four child nodes in the current node are all located at the upper plane position of the current node in the Z-axis direction. Therefore, it can be considered that the current node belongs to the Z plane and is an upper plane in the Z-axis direction.

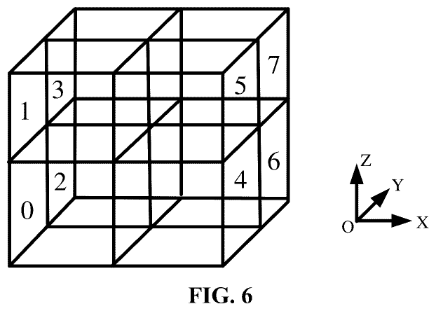

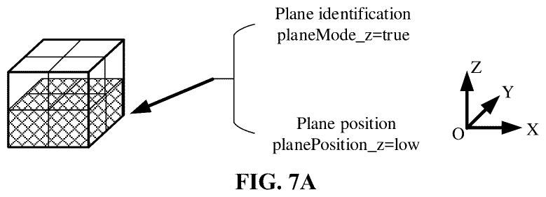

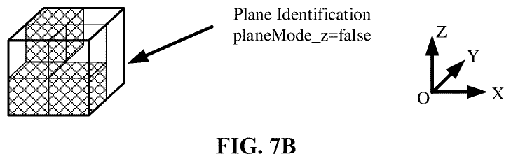

Furthermore, (a) of FIG. 5A is taken as an example, the efficiency of octree encoding is compared with the efficiency of planar encoding. FIG. 6 provides a schematic diagram of an encoding order for nodes, i.e., encoding is performed on the nodes in the order of 0, 1, 2, 3, 4, 5, 6, and 7 as shown in FIG. 6. If the octree encoding method is adopted for (a) in FIG. 5A, the occupancy information of the current node is expressed as: 11001100. However, if the planar encoding method is adopted, firstly, an identifier is required to be encoded to represent that the current node is a plane in the Z-axis direction; secondly, if the current node is a plane in the Z-axis direction, the plane position of the current node is required to be represented; and next, only the occupancy information of nodes (i.e., the occupancy information of the four child nodes 0, 2, 4, and 6) in the lower plane in the Z-axis direction is required to be encoded. Therefore, only 6 bits are required to be encoded when the current node is encoded based on the planar encoding method, which can reduce 2 bits compared with the octree encoding in the related art. Based on this analysis, planar encoding has obviously improved encoding efficiency compared with the octree encoding. Therefore, for an occupied node, if the planar encoding is used for encoding in a certain dimension, firstly, planar identifier (denoted as planarMode) information and plane position (denoted as PlanePos) information of the current node in this dimension are required to be represented, and secondly, the occupancy information of the current node is required to be encoded based on the plane information of the current node. Exemplarily, FIG. 7A shows a first schematic diagram of planar identifier information. As shown in FIG. 7A, a lower plane in the Z-axis direction is shown. Correspondingly, the value of the planar mode information is true or 1, i.e., planarMode_Z=true; and the plane position information is a lower plane (denoted as low), i.e., PlanePosition_Z=low. FIG. 7B shows another schematic diagram of planar mode information. As shown in FIG. 7B, it is not a plane in the Z-axis direction. Correspondingly, the value of the planar identifier information is false or 0, i.e., planarMode_Z=false.

It is to be noted that for PlaneMode_i: 0 represents that the current node is not a plane in the i-axis direction, and 1 represents that the current node is a plane in the i-axis direction. If the current node is a plane in the i-axis direction, then for PlanePosition_i: 0 represents that the current node is a plane in the i-axis direction and the plane position is a low plane, and 1 represents that the current node is an upper plane in the i-axis direction. Here, i represents a coordinate dimension, which may be the X-axis direction, the Y-axis direction, or the Z-axis direction, therefore, i=0, 1, 2.

In the G-PCC standard, it is determined whether a node satisfies the condition of the planar encoding and when the node satisfies the condition of the planar encoding, the predictive encoding is required to be performed on the planar mode information and plane position information of the node.

In the embodiments of the present disclosure, there are three kinds of conditions for determining whether a node satisfies the planar encoding in the current G-PCC standard, which are described in detail below.

First, determination is performed based on a plane probability of a node in each dimension.
(1) A local region density (denoted as local_node_density) of the current node is determined; and
(2) A probability Prob (i) of the current node in each dimension is determined.

When the local region density of the node is less than a threshold Th (e.g., Th=3), the plane probabilities Prob (i) of the current node in three coordinate dimensions are compared with thresholds Th0, Th1, and Th2, where Th0<Th1<Th2 (e.g., Th0-0.6, Th1-0.77, Th2=0.88). Here, Eligiblei (i=0, 1, 2) may be used to indicate whether the planar encoding is initiated in each dimension:

Eligiblei=Prob(i)>=threshold.

It is to be noted that the threshold is adaptively changed. For example, when Prob (0)>Prob (1)>Prob (2), Eligiblei is set as follows:

$$Elig {ible}_{0} = Prob ( 0 ) >= Th 1 ;$$

$${Eligible}_{1} = Prob ( 1 ) >= Th 0 ;$$

$${Eligible}_{2} = Prob ( 2 ) >= Th 2.$$

When Prob (1)>Prob (0)>Prob (2), then Eligiblei is set as follows:

$$Elig {ible}_{0} = Prob ( 0 ) >= Th 1 ;$$

$${Eligible}_{1} = Prob ( 1 ) >= Th 0 ;$$

$${Eligible}_{2} = Prob ( 2 ) >= Th 2.$$

Here, Prob (i) is updated as follows:

$$Prob {( i )}_{new} = ( L \times Prob ( i ) + δ ( encoded node ) / L + 1$$

Here, L=255. In addition, if a encoded node is a plane, then δ (encoded node) is 1; otherwise, δ (encoded node) is 0.

Here, the local_node_density is updated as follows:

$$local\_node {\_density}_{new} = local\_node \_density + 4 \times numSiblings$$

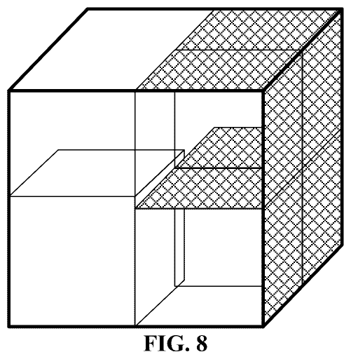

Here, local_node_density is initialized to be 4, and numSiblings is the number of sibling nodes of this node. Exemplarily, FIG. 8 is a schematic diagram of sibling nodes of a current node. As shown in FIG. 8, the current node is a node filled with slash lines, and nodes filled with a grid are sibling nodes. The number of sibling nodes of the current node is 5 (including the current node itself).

Second, based on the point cloud density of the current level, it is determined whether the node of the current level satisfies the planar encoding.

According to the density of points of the current level, it is determined whether the planar encoding is performed on a node in the current level. It is assumed that the number of points in the point cloud to be encoded currently is pointCount, and the number of points that have been reconstructed after Infer Direct Mode Coding (IDCM) is numPointCountRecon, and because the octree encoding is performed in breadth-first traversal order, it can be obtained that the number of nodes to be encoded on the current level is assumed to be nodeCount, and then determining whether the planar encoding is started to be performed on the current level is assumed as planarEligibleKOctreeDepth, specifically: lanarEligibleKOctreeDepth-(pointCount-numPointCountRecon)<nodeCount×1.3.

If (pointCount-numPointCountRecon) is less than nodeCount×1.3, then planarEligibleKOctreeDepth is true. If (pointCount-numPointCountRecon) is not less than nodeCount×1.3, then planarEligibleKOctreeDepth is false. In this way, when planarEligibleKOctreeDepth is true, the planar encoding is performed on all nodes of the current level; otherwise, the planar encoding is not performed on any of nodes of the current level, but only the octree encoding is performed.

Third, based on acquisition parameters for a lidar point cloud, it is determined whether a current node satisfies the planar encoding.

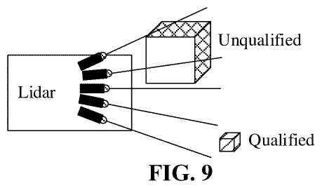

FIG. 9 is a schematic diagram of intersection between a lidar and nodes. As shown in FIG. 9, a node filled with a grid is passed through by two lasers, therefore, the current node is not a plane in the Z-axis vertical direction. A node filled with slash lines is too small to be passed through by two lasers, therefore, it is possible that the green node is a plane in the Z-axis vertical direction.

Furthermore, for a node satisfying the planar encoding condition, predictive encoding may be performed on the planar mode information and the plane position information of the node.

The first is predictive encoding of the planar identifier information.

Here, only three pieces of context information are used for encoding, i.e., context design is separately performed on the planar identifiers in all coordinate dimensions.

The second is predictive encoding of the plane position information.

It is to be understood that for the encoding of the plane position information of the non-LIDAR point cloud, predictive encoding of the plane position information may include followings.
(a) Occupancy information of a neighborhood node is used for prediction to obtain that the plane position information of a current node, which is the following three elements: predicted as a lower plane, predicted as a high plane and unpredictable.
(b) A spatial distance between the current node and a node having the same partitioning depth and the same coordinates as the current node is: “near” and “far”.
(c) If the node having the same partitioning depth and the same coordinates as the current node is a plane, the plane position of the node is determined.
(d) Coordinate dimensions (i=0, 1, 2).

It should be noted that, in the embodiments of the disclosure, after the spatial distance between the current node and a node having the same partitioning depth and the same coordinates as the current node is determined, if the spatial distance is shorter than a preset distance threshold, it is determined that the spatial distance is “near”; or, if the spatial distance is longer than the preset distance threshold, it is determined that the spatial distance is “far”.

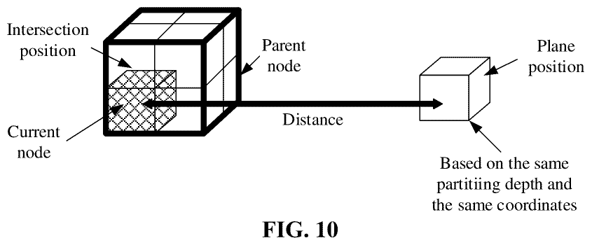

Exemplarily, FIG. 10 is a schematic diagram of neighborhood nodes at a same partitioning depth and having same coordinates as a current node. As shown in FIG. 10, the thickened big cube represents a parent node, a small cube filled with a grid in the thickened big cube represents the current node, and the vertex position is shown. Small cubes filled with white represent neighborhood nodes at the same partitioning depth and the same coordinates as the current node. The distances between the current node and the neighborhood nodes are spatial distances, which may be determined as “near” and “far”. Further, if the neighborhood nodes are a plane, plane position of the neighborhood nodes is required.

As such, as shown in FIG. 10, the current ode is the small cube filled with the grid, then the neighborhood node which is found at the same octree partitioning depth level and at the same coordinates is a small cube filled with white, it is determined that the distance between the two nodes is “near” and “far” with referring to the plane position of the node.

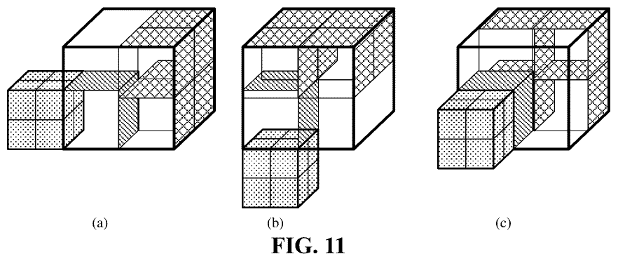

Further, in an embodiment of the present disclosure, FIG. 11 is a schematic diagram of a current node being located at a lower plane position of a parent node. As shown in FIG. 11, (a), (b), (c) show three examples in which the current node is located at a lower plane position of the parent node, which is specifically explained as follows.
(1) If any one of the child node 4 to child node 7 of the node filled with dots is occupied and none of the nodes filled with a grid is occupied, it is highly likely that a plane exists in the current node (filled with slashes) and the plane has a lower position.
(2) If none of the child node 4 to child node 7 of the node filled with dots is occupied and any of the nodes filled with a grid is occupied, it is highly likely that a plane exists in the current node (filled with slashes) and the plane has an upper position.
(3) If each of the child node 4 to child node 7 of the node filled with dots is a null node and each of the nodes filled with a grid is a null node, the plane position cannot be inferred, therefore, unknown is marked.
(4) If any one of the child node 4 to child node 7 of the node filled with dots is occupied and any one of the nodes filled with a grid is occupied, the plane position cannot be inferred, therefore, unknown is marked.

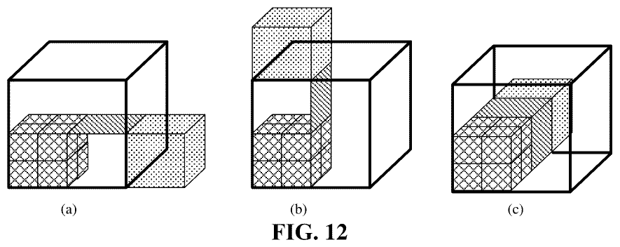

In an embodiment of the present disclosure, FIG. 12 is a schematic diagram of a current node being located at an upper plane position of a parent node. As shown in FIG. 12, (a), (b), (c) show three examples in which the current node is located at an upper plane position of the parent node, which is specifically explained as follows.
(1) If any one of the child node 4 to child node 7 of the node filled with a grid is occupied and the node filled with dots is not occupied, it is highly likely that a plane exists in the current node (filled with slashes) and the plane has a lower position.
(2) If none of the child node 4 to child node 7 of the node filled with a grid is occupied and the node filled with dots is occupied, it is highly likely that a plane exists in the current node (filled with slashes) and the plane has an upper position.
(3) If each of the child node 4 to child node 7 of the node filled with a grid is not occupied and the node filled with dots is not occupied, the plane position cannot be inferred, therefore, unknown is marked.
(4) If one of the child node 4 to child node 7 of the node filled with a grid is occupied and the node filled with dots is occupied, the plane position cannot be inferred, therefore, unknown is marked.

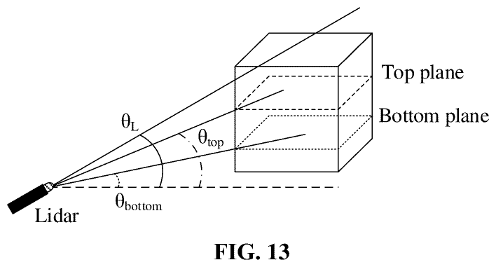

It is to be understood that for the encoding of plane position information of a lidar point cloud, FIG. 13 is a schematic diagram of predictive encoding of plane position information of a lidar point cloud. As shown in FIG. 13, when an emission angle of lidar is θ_{bottom}, it may be mapped to a lower plane (Bottom virtual plane). When an emission angle of the radar is θₜₒₚ, it may be mapped to an upper plane (Top virtual plane).

That is to say, the plane position of the current node is predicted by using acquisition parameters of the lidar, and the position is quantified into multiple intervals based on the position at which the current node intersects with the laser, and the multiple intervals are finally used as context information of the plane position of the current node. The specific calculation process is as follows: it is assumed that the coordinates of lidar are (x_{Lidar}, y_{Lidar}, z_{Lidar}), the geometric coordinates of the current node are (x, y, z), then the vertical tangent value tan θ of the current node relative to the lidar is firstly calculated, the calculation formula is as follows:

$$tan θ = \frac{z - {z}_{Lidar}}{\sqrt{{( x - {x}_{Lidar} )}^{2} + {( y - {y}_{Lidar} )}^{2}}}$$

Furthermore, since each laser has a certain offset angle relative to the lidar, it is also necessary to calculate a relative tangent value tan θ_{corr,L} of the current node relative to the laser, the specific calculation is as follows:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r}$$

The relative tangent value tan θ_{corr,L} of the current node may eventually be used to predict the plane position of the current node, as follows: it is assumed that the tangent value of the bottom boundary of the current node is tan θ_{bottom}, the tangent value of the top boundary of the current node is tan θₜₒₚ, according to tan θ_{corr,L}, the plane position is quantized into four quantization intervals, i.e., the context information of the plane position is determined.

However, the octree geometric information encoding mode has an efficient compression rate for only the points which have a correlation with each other in the space. For the points at isolated positions in the geometry space, the use of Direct Coding Model (DCM) can greatly reduce the complexity. For all nodes in the octree, the use of DCM is not represented by flag bit information, but inferred by using a parent node and neighbor information of a current node. There are three methods to determine whether a current node has a DCM encoding qualification, which are explained as follows.
(1) A current node has no sibling child nodes, i.e., the parent node of the current node has only one child node, and the parent node of the parent node of the current node has only two occupied child nodes, i.e., the current node has only one neighbor node at most.
(2) The parent node of the current node has only one occupied child node, i.e., the current node, and six neighbor nodes that share one surface with the current node are all null nodes
(3) The number of sibling nodes of the current node is greater than 1.

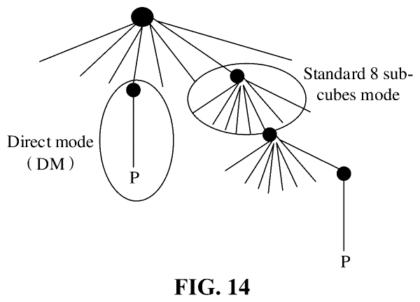

FIG. 14 provides a schematic diagram of IDCM encoding. As shown in FIG. 14, if a current node is not qualified for DCM encoding, octree partitioning is performed on the current node. If the current node is qualified for DCM encoding, the number of points included in the node may be further determined. When the number of points is less than a threshold (for example, 2), then the DCM encoding is performed on the node; otherwise, the octree partitioning may be continued to be performed. When the DCM encoding mode is applied, it is first necessary to encode whether the current node is a real isolated point, i.e., IDCM_flag. When the IDCM_flag is true, the DCM encoding is adopted for the current node; otherwise, the octree encoding is still adopted. When the current node satisfies the DCM encoding, it is necessary to encode the DCM encoding mode for the current node. At present, there are two DCM modes, namely: (a) only one point exists (or multiple points exist, but they are duplicate points); (b) there are two points. Finally, it is necessary to encode the geometric information of each point. It is assumed that the side length of the node is 2^{d}, d bits are required when each component of the geometric coordinates of the node is encoded, and the bit information is directly encoded into a bitstream. It is to be noted that when the lidar point cloud is encoded, by using the acquisition parameters of the lidar to perform the predictive encoding on the coordinate information in three dimensions, the encoding efficiency for geometric information can be further improved.

Then, the process of the IDCM encoding is introduced in detail.

When a current node satisfies the DCM, the number of points (numPoints) of the current node is firstly encoded, and the numPoints of the current node is encoded according to different DirectModes.

If the current node does not satisfy the requirements of the DCM node (i.e. the number of points is greater than 2, and the points are not duplicate points), it exits directly from the encoding process.

If the number of points (numPoints) included in the current node is less than or equal to 2, the encoding process is as follows.
1) Firstly, it is encoded whether the numPoints of the current node is greater than 1.
2) If the current node has only one point and the geometric encoding environment is geometry lossless encoding, it is necessary to encode the second point of the current node as a non-duplicate point.

If the number of points (numPoints) included in the current node is greater than 2, the encoding process is as follows.
1) Firstly, it is encoded that the numPoints of the current node is less than or equal to 1.
2) Secondly, it is encoded the second point of the current node as a duplicate point, and then, it is encoded whether the number of duplicate points of the current node is greater than 1. When the number of duplicate points is greater than 1, exponential Columbus decoding is required to be performed on the number of remaining duplicate points.

After the number of points of the current node is encoded, coordinate information of the points included in the current node is encoded. The following will separately introduce a lidar point cloud and a human eye-oriented point cloud.

Human eye-oriented point cloud
1) If a current node includes only one point, direct encoding (bypass encoding) may be performed on geometric information of the point in the three dimensional directions.
2) If the current node includes two points, the firstly encoded coordinate axis dirextAxis may be obtained firstly by using the geometric coordinates of the points. It is to be noted that the coordinate axes currently compared include only the x axis and y axis without the z axis. It is assumed that the geometric coordinates of the current node are nodePos, the determination method is as follows:

$$dirextAxis = ! ( nodePos [ 0 ] < nodePos [ 1 ] )$$

That is to say, the axis with a smaller geometric coordinate position of a node is used as the firstly encoded coordinate axis dirextAxis, and secondly, the geometric information of the firstly encoded coordinate axis dirextAxis is firstly encoded as follows: it is assumed that the geometry bit to be encoded which corresponds to the firstly encoded axis has a depth of nodeSizeLog 2, and it is assumed that the coordinates of the two points are pointPos[0] and pointPos[1], respectively.

```
  Bool sameBit=true;
  while (nodeSizeLog2&& sameBit){
    int mask=1<< nodeSizeLog2;
    −−nodeSizeLog2;
    bool bit0=!!( pointPos[0]& mask)
bool bit1=!!( pointPos[1]& mask)
    sameBits=bit0==bit1;
    entropyCodeSameBit(sameBits); ///<entropy encoding
    if (sameBits)
      encodePosBit(bit0); ///<Bypass encoding
}
```

After the firstly encoded axis dirextAxis is encoded, the direct encoding is performed on the geometric coordinates of the current point. It is assumed that the remaining bit to be encoded of each point has a depth of nodeSizeLog 2, the specific encoding process is as follows:

for(int axisIdx=0; axisIdx<3; ++axisIdx)
for(int mask=(1<< nodeSizeLog2[axisIdx])>>1; mask; mask>>1)
encodePosBit(!!(pointPos[axisIdx]&mask));
Lidar-oriented point cloud

If a current node includes two points, the firstly encoded coordinate axis dirextAxis may be obtained firstly using the geometric coordinates of the points. It is assumed that the geometric coordinates of the current node are nodePos, the determination method is as follows:

$$dirextAxis = ! ( nodePos [ 0 ] < nodePos [ 1 ] ) .$$

That is to say, the axis with a smaller geometric coordinate position of a node (nodePos) is used as the firstly encoded coordinate axis dirextAxis. It is to be noted that the coordinate axes currently compared include only the x axis and y axis without the z axis. Secondly, the geometric information of the firstly encoded coordinate axis dirextAxis is firstly encoded as follows: it is assumed that the geometry bit to be encoded which corresponds to the firstly encoded axis has a depth of nodeSizeLog 2, and it is assumed that the coordinates of the two points are pointPos[0] and pointPos[1], respectively, the specific encoding process is as follows.

```
  Bool sameBit=true;
  while(nodeSizeLog2&& sameBit){
    int mask=1<< nodeSizeLog2;
    −−nodeSizeLog2;
    bool bit0=!!( pointPos[0]& mask)
bool bit1=!!( pointPos[1]& mask)
    sameBits=bit0==bit1;
    entropyCodeSameBit(sameBits);
    if(sameBits)
      encodePosBit(bit0);
}
```

After the firstly encoded axis dirextAxis is encoded, encoding is performed on the geometric coordinates of the current point.

Since a lidar point cloud may obtain the acquisition parameters of lidar point cloud, by using the geometry coordinate information which may be used for predicting a current node the encoding efficiency for the geometric information of the point cloud may be improved. Similarly, firstly, the geometric information nodePos of the current node is used to obtain a directly encoded main axis direction, and secondly, the geometric information of the encoded direction is used to perform predictive encoding on geometric information of another dimension. Similarly, it is assumed that the directly encoded axis direction is directAxis, and it is assumed that the bit to be encoded in the direct encoding has a depth of nodeSizeLog 2, the encoding method is as follows:

for (int mask=(1<< nodeSizeLog2)>>1; mask; mask>>1)
encodePosBit(!!(pointPos[directAxis]&mask));

It is to be noted that all the geometry precision information of the directAxis direction may be encoded herein.

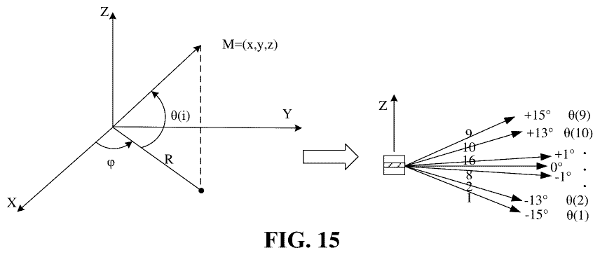

FIG. 15 is a schematic diagram of coordinate transform of a point cloud obtained by rotating a lidar. In the Cartesian coordinate system, the (x, y, z) coordinates of each node may be converted to (R, φ, i). In addition, the Laser Scanner may perform laser scanning at a preset angle, and different θ (i) can be obtained under different values of i. For example, when i is equal to 1, θ (1) may be obtained at this time, and the corresponding scanning angle is −15°; when i is equal to 2, θ (2) may be obtained at this time, and the corresponding scanning angle is −13°; when i is equal to 10, θ (10) may be obtained at this time, and the corresponding scanning angle is +13°; when i is equal to 9, θ (19) may be obtained at this time, and the corresponding scanning angle is +15°

After encoding all the precision of the coordinate direction directAxis, the LaserIdx corresponding to a current point, such as the pointLaserIdx in FIG. 15, is firstly calculated; and the LaserIdx of a current node, i.e., nodeLaserIdx, is calculated. Then, predictive encoding may be performed on the LaserIdx of a point, i.e., pointLaserIdx, by using the LaserIdx of the node, i.e., nodeLaserIdx. Here, the calculation method of LaserIdx of a node or the LaserIdx of a point is as follows: it is assumed that the geometric coordinates of the point is pointPos and the starting coordinates of Laser is LidarOrigin, and it is assumed that the number of lasers is LaserNum, the tangent value of each laser is tan θi, and the offset position of each laser in the vertical direction is Zᵢ, then:

Int bestLaserIdx=0;

```
    Int Distoration=INT_MAX;
For(int LaserIdx=0; LaserIdx<numLaser;++ LaserIdx){
  int radius = \sqrt{(pointPos[0] − LidarOrigin[0])2 + (pointPos[1] − LidarOrigin[1])2}
      int invRadius=1/ radius
      int Z=pointPos[2]+ Zᵢ
      int tanTheta= Z×invRadius
      if(std::abs(tanTheta−tanθᵢ)< Distoration){
Distoration= std::abs(tanTheta−tanθᵢ);
bestLaserIdx= LaserIdx;
}
}
```

After the LaserIdx of the current node is calculated, predictive encoding is performed on the pointLaserIdx of a point by using the LaserIdx of the current node. After the LaserIdx of the current point is encoded, predictive encoding is performed on the three-dimensional geometric information of the current point by using the acquisition parameters of the lidar.

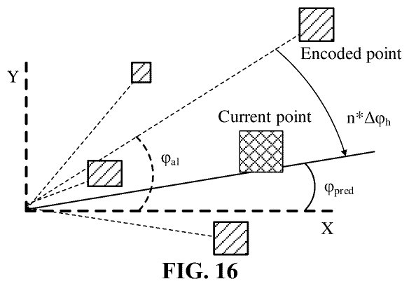

For the predictive encoding, FIG. 16 is a schematic diagram of predictive encoding in the x axis or y axis. As shown in FIG. 16, a box filled with grid represents the Current node, and boxes filled with slash lines represent the already coded node. Here, first, the LaserIdx corresponding to the current node is used to obtain the predicted value of the corresponding horizontal azimuth angle, that is, φ_{pred}. Then, the horizontal azimuth angle φ_{node} corresponding to the node is obtained by using the node geometric information corresponding to the current node. Herein, it is assumed that the geometric coordinates of the node are nodePos, then the calculation method between the horizontal azimuth q and the geometric information of the node is as follows:

$$φ = arctan ( \frac{node Pos [ 1 ]}{nodePos [ x ]} )$$

By using the acquisition parameters of the lidar, the number of rotation points (numPoints) of each laser may be obtained, which represents the number of points obtained by rotating each laser once, and the rotation angular velocity deltaPhi of each laser may be calculated using the number of rotation points of each laser, i.e.:

$$deltaPhi = \frac{2 π}{numPoints}$$

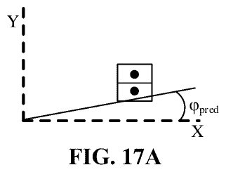

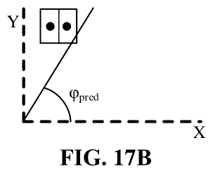

The horizontal azimuthal angle φ_{pred} of the node and the horizontal azimuthal angle φ_{pred} of the previous encoded point of Laser corresponding to the current point are used to calculate to obtain the predicted value φ_{predPoint} of the horizontal azimuthal angle corresponding to the current point, i.e., the predicted value of the horizontal azimuthal angle as shown in FIG. 17A and FIG. 17B. FIG. 17A shows an angular diagram of predicting the Y-plane by using a horizontal azimuth angle, and FIG. 17B shows an angular diagram of predicting the X-plane by using a horizontal azimuth angle. Here, the calculation method for the horizontal azimuth prediction value φ_{predPoint} corresponding to the current point is as follows:

$${φ}_{p r e d P o i n t} = \frac{φ pred - φ node}{deltaPhi} \times delta Phi + φ pred$$

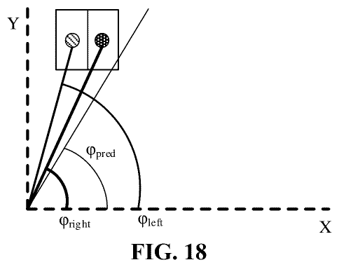

FIG. 18 is another schematic diagram of predictive encoding on the X axis or Y axis. As shown in FIG. 18, the portion filled with grid (left side) represents the low plane, the portion filled with dots (right side) represents the high plane, φ_{left} represents horizontal azimuth angle of the low plane of the current node, φ_{right} represents the horizontal azimuth angle of the high plane of the current node, and φ_{pred} represents a prediction value of a horizontal azimuth angle corresponding to the current node.

As such, the predictive encoding is performed on the geometric information of a current node using the prediction value φ_{predPoint} of the horizontal azimuthal angle, the horizontal azimuthal angle φ_{left} of the low plane of the current node and the horizontal azimuthal angle φ_{right} of the top plane of the current node. The calculation method is specifically as follows.

$$\begin{matrix}int angLel = {φ}_{left} - {φ}_{pred} ; \\ int angLeR = {φ}_{right} - {φ}_{pred} ; \\ int context = ( angLel \geq 0 \&\& angLeR \geq 0 ) ‖ ( angLel < 0 \&\& angLeR < 0 ) ? 0 : 2 ; \\ int min Angle = std \text{::} min ( abs ( angLel ) , abs ( angLeR ) ) ; \\ int max Angle = std \text{::} min ( abs ( angLel ) , abs ( angLeR ) ) ; \\ context += > max Angle ? 0 : 1 \\ context += > min Angle ? 0 : 4.\end{matrix}$$

After the LaserIdx of a point is encoded, predictive encoding may be performed on the current point in the Z-axis direction by using the LaserIdx corresponding to the current point. That is to say, the depth information radius of a lidar coordinate system is calculated by using the x-axis and y-axis information of the current point, and the tangent value for the current point and the offset of the current point in the vertical direction are obtained using the laser LaserIdx of the current point, so that the predicted value of the current point in the Z-axis direction, i.e., Z_pred, may be obtained:

$$\begin{matrix}int radius = \sqrt{( pointPos [ 0 ] - LidarOrigin [ 0 ] ) 2 + ( pointPos [ 1 ] - LidarOrigin [ 1 ] ) 2 ;} \\ int tanTheta = tan {θ}_{laserIdx} ; \\ int zOffset = {Z}_{laserIdx} ; \\ Z\_pred = radius \times tanTheta - zOffset .\end{matrix}$$

Finally, predictive encoding is performed on the geometric information of the current point in the Z-axis direction by using the Z_pred to obtain a prediction residual Z_res. Finally, Z_res is encoded.

It is also to be noted that when node partitioning is performed to a leaf node, the number of duplicate points in the leaf node is required to be encoded in the case of lossless geometric encoding. Finally, the occupancy information of all nodes is encoded to generate a binary bitstream. In addition, a planar encoding mode is currently introduced into the G-PCC. During geometric partitioning, it may be determined whether the child nodes of a current node are located in the same plane. If the child nodes of the current node are in the same plane, the plane may be used to represent the child nodes of the current node.

For octree geometric decoding, before the occupancy information of each node is decoded in breadth-first traversal order, the decoding end may firstly determine based on reconstructed geometric information whether to perform planar decoding or IDCM decoding on a current node. If the current node satisfies the planar decoding condition, the planar identifier information and plane position information of the current node may be firstly decoded, and then the occupancy information of the current node is decoded based on the plane information. If the current node satisfies the IDCM decoding condition, it may be firstly parsed whether the current node is a true IDCM node, and if the current node is a true IDCM node, parsing may be continued to obtain the DCM decoding mode of the current node; secondly, the number of points in the current DCM node may be obtained, and finally the geometric information of each point may be decoded. For a node that satisfies neither planar decoding nor DCM decoding, decoding may be performed for the occupancy information of the current node. Parsing is performed continuously in this way to obtain a occupancy code of each node, and node partitioning continues in sequence until a unit cube with a size of 1×1×1 is obtained by such partitioning, the number of points included in each leaf node is obtained by such parsing, and finally the geometric reconstructed point cloud information is recovered.

Hereafter, the process of IDCM decoding is introduced in detail.

Similar to the encoding process, firstly, prior information is used to determine whether IDCM is started for a node, i.e., the starting conditions for IDCM are as follows.
(1) A current node has no sibling child nodes, i.e., the parent node of the current node has only one child node, and the parent node of the parent node of the current node has only two occupied child nodes, i.e., the current node has only one neighbor node at most.
(2) The parent node of the current node has only one occupied child node, i.e., the current node, and six neighbor nodes that share one surface with the current node are all null nodes.
(3) The number of sibling nodes of the current node is greater than 1.

When the node satisfies the DCM encoding condition, it is necessary to firstly decoded whether the current node is a true DCM node, i.e., IDCM_flag. When IDCM_flag is true, DCM encoding is adopted for the current node; otherwise, octree encoding is still adopted.

Secondly, the number of points (numPoints) of the current node is decoded. The specific decoding method is as follows.
i) Firstly, it is decoded whether the numPoints of the current node is greater than 1.
ii) If the numPoints of the current node obtained by decoding is greater than 1, the decoding is continued to obtain whether a second point is a duplicate point. If the second point is not a duplicate point, it may be implicitly inferred that the current node satisfies the second type of DCM mode and includes only two points.
iii) If the numPoints of the current node obtained by decoding is less than or equal to 1, the decoding is continued to obtain whether a second point is a duplicate point. If the second point is not a duplicate point, it may be implicitly inferred that the current node satisfies the second type of DCM mode and includes only one point. If it is determined by decoding that the second point is a duplicate point, it may be inferred that the current node satisfies the third type of DCM mode and includes multiple points that are duplicate points; then the decoding (entropy decoding) is continued to determine whether the number of the duplicate points is greater than 1. If the number of the duplicate points is greater than 1, the decoding (by using exponential Columbus) is continued to obtain the number of remaining duplicate points.

If the current node does not satisfy the requirements of the DCM mode, it exits directly (i.e. the number of points is greater than 2, and the points are not duplicate points) from decoding.

After the number of points of the current node is decoded, coordinate information of the points included in the current node is decoded. The following will separately introduce a lidar point cloud and a human eye-oriented point cloud.

### Human Eye-Oriented Point Cloud

1) If a current node includes only one point, direct encoding (bypass encoding) may be performed on the three-dimensional geometric information of the point.
2) If the current node includes two points, the priority-decoded coordinate axis dirextAxis may be obtained firstly by using the geometric coordinates of the points. It is to be noted herein that the coordinate axes currently in comparison include only the x axis and y axis without the z axis. It is assumed that the geometric coordinates of the current node are nodePos, the determination method is as follows.

$$dirextAxis = ! ( nodePos [ 0 ] < nodePos [ 1 ] ) .$$

That is to say, the axis with a smaller geometric coordinate position of a node is used as the firstly decoded coordinate axis dirextAxis, and secondly, the geometric information of the firstly decoded coordinate axis dirextAxis is firstly decoded as follows: it is assumed that the geometry bit to be decoded corresponding to the firstly decoded axis has a depth of nodeSizeLog 2, and it is assumed that the coordinates of the two points are pointPos[0] and pointPos[1], respectively. The specific coding process is as follows:

```
Bool sameBit=true;
while(nodeSizeLog2&& sameBit){
    pointPos[0][ dirextAxis]<<1;
    pointPos[1][ dirextAxis]<<1;
    −−nodeSizeLog2;
    int bit=0;
    deEntropyCodeSameBit(sameBits); ///<entropy encoding
    if(sameBits){
        bit =decodePosBit( );///<Bypass encoding
        pointPos[0][ dirextAxis]|= bit
        pointPos[1][ dirextAxis]|= bit
    }else
      pointPos[1][ dirextAxis]|= 1///< The reason is that:
  during encoding, two points are sorted in the firstly encoded
  axis direction, so it may be ensured that
  pointPos[0][dirextAxis]<pointPos[1][dirextAxis]. Therefore,
  during decoding, if the pieces of bit information of two points
  are different, it may be inferred that the bit of the first point is
  0 and the bit of the second point is 1.
}
```

After the firstly decoded coordinate axis dirextAxis is decoded, direct decoding is performed on the geometric coordinates of the current point. It is assumed that the remaining bit to be encoded of each point has a depth of nodeSizeLog 2 and it is assumed that the coordinate information of the point is pointPos, the specific decoding process is as follows:

$$\begin{matrix}for ( int axisIdx = 0 ; axisIdx < 3 ; ++ axisIdx ) \\ for ( int idx = nodeSizeLog 2 [ a x i s I dx ] ; idx ; idx -- ) \{ \\ pointPos [ axisIdx ] << 1 ; \\ pointPos [ axisIdx ] \vert = decodePosBit ( ) ;\end{matrix}$$

### Lidar-Oriented Point Cloud

1) If a current node includes two points, the firstly-decoded coordinate axis dirextAxis may be obtained firstly using the geometric coordinates of the points. It is assumed that the geometric coordinates of the current node are nodePos, the determination method is as follows:

dirextAxis=!(nodePos[0]<nodePos[1]).

That is to say, the axis with a smaller geometric coordinate position of a node is used as the firstly decoded coordinate axis dirextAxis. It is to be noted that the coordinate axes currently compared include only the x axis and y axis without the z axis. Secondly, the geometric information of the firstly decoded coordinate axis dirextAxis is firstly decoded as follows: it is assumed that the geometry bit to be encoded corresponding to the firstly decoded axis has a depth of nodeSizeLog 2, and it is assumed that the coordinates of the two points are pointPos[0] and pointPos[1], respectively. The specific coding process is as follows:

```
Bool sameBit=true;
while(nodeSizeLog2&& sameBit){
  pointPos[0][ dirextAxis]<<1;
  pointPos[1][ dirextAxis]<<1;
  --nodeSizeLog2;
  int bit=0;
  deEntropyCodeSameBit(sameBits); ///<entropy encoding
  if(sameBits){
      bit =decodePosBit( );///<Bypass encoding
      pointPos[0][ dirextAxis]|= bit
      pointPos[1][ dirextAxis]|= bit
  }else
    pointPos[1][ dirextAxis]|= 1///< The reason is that:
    during encoding, two points are sorted in the firstly
    encoded direction, so it may be ensured that
    pointPos[0][dirextAxis]<pointPos[1][dirextAxis].
    Therefore, during decoding, if the pieces of bit
    information of two points are different, it may be
    inferred that the bit of the first point is 0 and the bit of
    the second point is 1.
}
```

After the firstly decoded axis dirextAxis is decoded, decoding is performed on the geometric coordinates of the current point.

Similarly, firstly, the geometric information nodePos of the current node is used to obtain a bypass decoded main axis direction, and secondly, the geometric information of the decoded direction is used to decode the geometric information of another dimension. Similarly, it is assumed that the bypass decoded axis direction is directAxis, and it is assumed that the bit to be decoded in the bypass decoding has a depth of nodeSizeLog 2, the decoding method is as follows:

```
For(int idx= nodeSizeLog2[directAxis]; idx; idx--){
  pointPos[directAxis]<<1;
  pointPos[directAxis]|=decodePosBit( );
}
```

It is to be noted that all the geometry precision information of the directAxis direction may be decoded.

After all the precision of the coordinate direction directAxis is decoded, the LaserIdx of a current node, i.e., nodeLaserIdx, is calculated. Secondly, predication decoding may be performed on the LaserIdx of a point, i.e., pointLaserIdx, by using the LaserIdx of the node, i.e., nodeLaserIdx. Here, the calculation method for LaserIdx of the node or the LaserIdx of the point is as those at the encoding end. Finally, decoding is performed on the prediction residual information of LaserIdx of the current point and the LaserIdx of the node to obtain ResLaserIdx, then and the decoding method is as follows:

$$PointLaserIdx = nodeLaserIdx + ResLaserIdx$$

After the LaserIdx of the current point is decoded, prediction decoding is performed on the three-dimensional geometric information of the current point using the acquisition parameters of lidar. The specific algorithm is as follows:

As shown in FIG. 11, firstly, a predicted value, i.e., φ_{pred}, of a corresponding horizontal azimuthal angle is obtained by using the LaserIdx corresponding to a current point. Secondly, a horizontal azimuthal angle φ_{node} corresponding to a node is obtained by using the geometric information of the node corresponding to the current point. Here, assuming that the geometric coordinate of the node is nodePos, the calculation method between the horizontal azimuthal angle φ and the geometric information of the node is as follows.

$$φ = arctan ( nodePos [ 1 ] / nodePos [ 0 ] )$$

By using the acquisition parameters of lidar, the number of rotation points numPoints of each Laser can be obtained, that is, the number of points obtained by rotating each Laser ray once, and the rotation angular velocity deltaPhi of each Laser can be calculated by using the number of rotation points of each Laser. The calculation method is as follows:

$$deltaPhi = \frac{2 π}{numPoints}$$

Further, a prediction value φ_{predPoint} of the horizontal azimuth angle corresponding to the current point, that is, the prediction value of the horizontal azimuth angle shown in FIGS. 17A and 17B, is calculated by using the horizontal azimuth angle φ_{node} of the node and the horizontal azimuth angle φ_{pred} of the previous coding point of the Laser corresponding to the current point. It is calculated as follows:

$${φ}_{predPoint} = \frac{φ pred - φ node}{deltaPhi} \times deltaPhi + φ pred$$

As such, predictive encoding is performed on the geometric information of a current node by finally using the predicted value φ_{predPoint} of a horizontal azimuthal angle, the horizontal azimuthal angle φ_{left} of the low plane of the current node and the horizontal azimuthal angle φ_{righ} of the top plane of the current node, the calculation method is specifically as follows.

$$int angLel = {φ}_{left} - {φ}_{pred} ;$$

$$int angLeR = {φ}_{right} - {φ}_{pred} ;$$

$$int context = ( angLel \geq 0 \&\& angLeR \geq 0 \vert \vert ( angLel < 0 \&\& angLeR < 0 ) ? 0 : 2 ;$$

$$int abs AngleL = abs ( angLel ) ;$$

$$int abs AngleR = abs ( angLeR ) ;$$

$$context += abs AngleL > abs AngleR ? 0 : 1 ;$$

$$context += max Angle > min Angle ≪ 1 ? 4 : 0.$$

After the LaserIdx of a point is decoded, prediction decoding may be performed on the current point in the Z-axis direction by using the LaserIdx corresponding to the current point. That is to say, the depth information radius of a radar coordinate system is firstly calculated by using the x-axis and y-axis information of the current point, and secondly, the tangent value of the current point and the offset of the current point in the vertical direction are obtained using the laser LaserIdx of the current point, so that the predicted value of the current point in the Z-axis direction, i.e., Z_pred, can be obtained. Specifically as follows:

$$int radius = \sqrt{( pointPos [ 0 ] - LidarOrgin [ 0 ] 2 + ( pointPos [ 1 ] - LidarOrgin [ 1 ] ) 2} ;$$

$$int tan Theta = tan {θ}_{laserIdx} ;$$

$$int zOffset - {Z}_{laserIdx} ;$$

$$Z\_pred = radius \times tan Theta - zOffset .$$

Finally, Z_res and Z_pred obtained by decoding are used to reconstruct and restore the geometric information of the current point in the Z-axis direction.

For the triangle soup (trisoup)-based geometric information encoding, in the trisoup-based geometric information encoding framework, geometric partitioning is also performed firstly, but different from the binary tree/quadtree/octree-based geometric information encoding, the trisoup-based geometric information encoding does not need to progressively partition a point cloud into unit cubes each with the size of 1×1×1, but stops the partitioning when an edge length of a block (sub-block) is W. Based on a surface formed by distribution of the point cloud in each block, at most twelve vertexes generated by the surface and twelve edges of the block are obtained. The vertex coordinates of each block are encoded in turn to generate a binary bitstream.

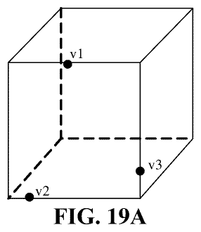

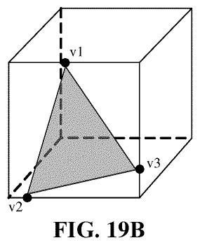

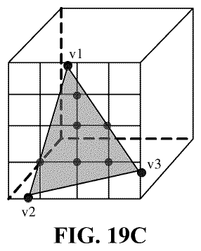

For trisoup-based point cloud geometric information reconstruction, when point cloud geometric information reconstruction is performed at the decoding end, vertex coordinates are firstly decoded to complete the triangle soup reconstruction, and the process is shown in FIG. 19A, FIG. 19B and FIG. 19C. Here, there are three vertexes (v1, v2, v3) in the block as shown in FIG. 19A, and a triangle soup formed by these three vertexes in a certain order is called triangle soup, i.e., trisoup, as shown in FIG. 19B. Then, sampling is performed on the triangle soup, and the obtained sampling points are used as the reconstructed point cloud in the block, as shown in FIG. 19C.

For geometric encoding based on a prediction tree (predictive geometric encoding, PredGeom Tree), the geometric encoding based on a prediction tree includes: sorting input point clouds. Currently used sorting methods include: no order, Morton order, azimuth order, or radial distance order. At the encoding end, the prediction tree structure is established in two different manners including: k-dimensional tree (KD-Tree) (that is a high-delay slow mode) and a low-delay fast mode (which uses lidar calibration information). When the lidar calibration information is used, all points are partitioned onto different lasers, and a prediction structure is established based on different lasers. Then, based on the structure of the prediction tree, all nodes in the prediction tree are traversed; and the geometric position information of each node is predicted by using different prediction modes to obtain prediction residuals, and the geometric prediction residuals are quantized by quantization parameters. Finally, the prediction residual, prediction tree structure and quantization parameters of node position information in prediction tree are encoded through continuous iteration to generate a binary bitstream.

For the geometric encoding based on a prediction tree, the decoding end synthesizes the prediction tree structure by continuously parsing the bitstream, and then obtains prediction residual information and quantization parameters of the geometric position of each prediction node through the parsing. The inverse quantization is performed on the prediction residual to recover and obtain the reconstructed geometric position information of each node, and finally the geometric reconstruction is completed at the decoding end.

After the geometric encoding is completed, the geometric information is required to be reconstructed. At present, attribute encoding is mainly for color information. Firstly, color information is transformed from RGB space to YUV space. Then, a point cloud is re-shaded by using reconstructed geometric information, so that un-encoded attribute information corresponds to the reconstructed geometric information. In the process of color information encoding, two transform methods exist: one is a distance-based lifting transform depending on LOD partitioning, and another is a direct RAHT. In both two methods, color information will be transformed from a spatial domain to a frequency domain, high-frequency coefficients and low-frequency coefficients will be obtained through the transform, and then the coefficients are quantized and encoded to generate a binary bitstream, as shown in FIG. 4A and FIG. 4B for details.

When prediction is performed on attribute information based on geometric information, nearest-neighbor search may be performed by using Morton codes, and the Morton code corresponding to each point in a point cloud may be obtained from geometric coordinates of the point. The specific method of calculating Morton codes is described as follows. For 3D coordinates where each component is represented by using a d-bit binary number, three components thereof are represented as:

$$x = {\sum }_{ℓ = 1}^{d} {2}^{d - ℓ} {x}_{ℓ} , y = {\sum }_{ℓ = 1}^{d} {2}^{d - ℓ} {y}_{ℓ} , z = {\sum }_{ℓ = 1}^{d} {2}^{d - ℓ} {z}_{ℓ}$$

Here, [symbol] , [symbol] , [symbol] ∈{0,1} are binary numbers respectively corresponding to the highest bit ( [symbol] =1) to the lowest bit ( [symbol] =d) of x, y, and z. In the Morton code M, starting from the highest bit of x, y, and z, [symbol] , [symbol] , [symbol] are arranged alternately in turn to the lowest bit. The calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}}$$

Here, [symbol] ∈{0,1} are values from the highest bit ( [symbol] =1) of M to the lowest bit ( [symbol] =3d) of M, respectively. After the Morton code M of each point in the point cloud is obtained, the points in the point cloud are arranged according to the Morton codes in an ascending order, and the weight value w of each point is set to be 1.

It is also to be understood that for the G-PCC codec framework, the common test conditions are as follows.
(1) There are 4 kinds of test conditions:
Condition 1: limited lossy for geometric position, and lossy for attribute;
Condition 2: lossless for geometric position and lossy for attribute;
Condition 3: lossless for geometric position and limited lossy for attribute; and
Condition 4: lossless for geometric position and lossless for attribute.
(2) The common test sequence includes four categories: Cat1A, Cat1B, Cat3-fused, and Cat3-frame. The Cat2-frame point cloud includes only reflectance attribute information, the Cat1A point cloud and Cat1B point cloud include only color attribute information, and the Cat3-fused point cloud includes both color and reflectance attribute information.
(3) For the technology roadmaps, there are two types in total, which are distinguished by algorithms used in geometry compression.

### Technology Roadmap 1: Octree Encoding Branch

At the encoding end, a bounding box is partitioned in sequence to obtain sub-cubes, and non-empty sub-cubes (including points in a point cloud) are continuously partitioned until partitioned leaf nodes become unit cubes each with a size of 1×1×1. In the case of geometry lossless encoding, the number of points included in the leaf nodes is required to be encoded, and finally the geometry octree encoding is completed to generate a binary bitstream.

At the decoding end, according to the breadth-first traversal order, the decoding end continuously performs parsing to obtain the occupancy code of each node, and node partitioning is continuously performed in sequence until a unit cube with a size of 1×1×1 is obtained by the partitioning. In the case of lossless geometric decoding, it is necessary to obtain the number of points included in each leaf node by the parsing, and finally geometric synthesis information of the point cloud is recovered.

### Technology Roadmap 2: Prediction Tree Encoding Branch

At the encoding end, the prediction tree structure is established in two different manners including: a manner of depending on k-dimensional tree (KD-Tree) (which is a high-delay slow mode) and a manner of using lidar calibration information (which is a low-delay fast mode). By using the lidar calibration information, all points are partitioned onto different lasers, and the prediction structure is established according to different lasers. Then, based on the structure of the prediction tree, all nodes in the prediction tree are traversed; and the geometric position information of each node is predicted by using different prediction modes to obtain prediction residuals, and the geometric prediction residuals are quantized by quantization parameters. Finally, the prediction residual, prediction tree structure and quantization parameters of node position information in prediction tree are encoded through continuous iteration to generate a binary bitstream.

At the decoding end, the decoding end reconstructs the prediction tree structure by continuously parsing the bitstream, and then obtains prediction residual information and quantization parameters of the geometric position of each prediction node through the parsing. The inverse quantization is performed on the prediction residual to recover and obtain the reconstructed geometric position information of each node, and finally the geometric reconstruction is completed at the decoding end.

It should be noted that, as shown in FIG. 4A and FIG. 4B, the current G-PCC encoding framework includes three attribute encoding methods: a Predicting Transform (PT), lifting transform (LT) and an RAHT. The PT and LT depend on the generation order of LODs to perform predictive encoding on a point cloud, while the RAHT performs adaptive transform on attribute information from bottom to top based on the construction levels of octree. These three point cloud attribute encoding methods will be described below, respectively.

### (a) Predictive Encoding for the Attribute Information of the Point Cloud

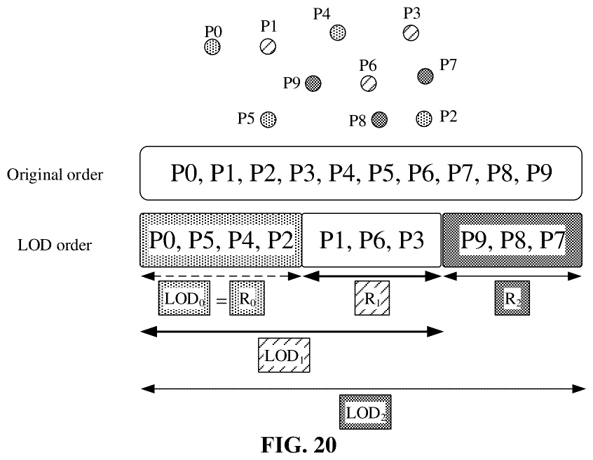

The current attribute prediction module of the G-PCC adopts the nearest neighbor attribute predictive encoding scheme based on the LOD structure. The LOD construction scheme includes: a distance-based LOD construction scheme, a fixed sampling rate-based LOD construction scheme, and an octree-based LOD construction scheme, etc. In the distance threshold-based LOD construction scheme, before LOD is constructed, Morton sorting is performed on a point cloud to ensure strong attribute correlation between adjacent points. FIG. 20 is a schematic diagram of a distance-based LOD construction process. As shown in FIG. 20, the point cloud is partitioned into L different levels of detail of the point cloud (Rl), where l=0, 1, . . . . L−1, according to L Manhattan distances (dl), where l=0, 1, . . . . L−1 and (dl) l=0, 1, . . . . L−1 satisfies dl<dl−1, that is preset in advance. An LOD construction process include following four operations:
(1) all points in the point cloud are marked as “un-accessed”, and a set V is established to store the accessed points; (2) for each iteration 1, the points in the point cloud are traversed; if the current point has been accessed, the current point is ignored; otherwise, the minimum distance D from the current point to the point set V is calculated, and the current point is ignored if D<dl; otherwise, the current point is marked as accessed and the current point is added into the detailed level R1 and the point set V; (3) the points in LOD/are composed of points in the detailed levels R0, R1, R2 . . . . Rl; and (4) the above steps are repeated continuously until all points are marked as accessed.

On the basis of the structure of LOD, the attribute value of each point is obtained by performing linear weighted prediction by using the reconstructed attribute value of the points in the same LOD or a higher LOD. The maximum number of referred neighbors is determined by a high level syntax element of an encoder. For the attribute of each point, at the encoding end, the attributes of searched N nearest neighbor points selected by using the rate-distortion optimization algorithm may be used to perform weighted prediction, or an attribute of a selected single nearest neighbor point may be used to perform the prediction. The selected prediction mode and prediction residual are encoded.

$${Attr}_{i}^{′} = Round ( \frac{1}{N} {\sum }_{m ∈ {p}_{i}} \frac{\frac{1}{{D}_{m}^{2}}}{{\sum }_{m ∈ {p}_{i}} \frac{1}{{D}_{m}^{2}}} A t t {r}_{m} )$$

N represents the number of prediction points in the nearest neighbor point set of point i, Pi represents a set of N nearest neighbor points of the point i, Dm represents the spatial geometric distance from the nearest neighbor point m to the current point i, Attrm represents the reconstructed attribute value of the nearest neighbor point m, Attrᵢ′ represents the predicted attribute value of the current point i, and the number N of points is a preset value in advance.

In order to balance the attribute encoding efficiency and the parallel processing between different LODs, a switch is introduced into the high level syntax element of the encoder to control whether to introduce intra LOD prediction. If the switch is turned on, intra LOD prediction is started, and the prediction may be performed by using the points in the same LOD. It is to be noted that the intra LOD prediction is always used when the number of the LODs is 1.

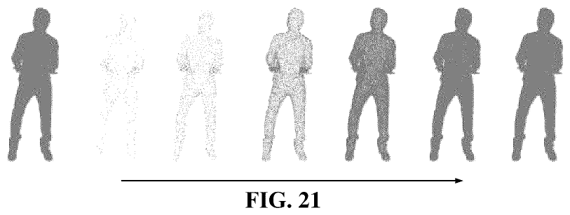

FIG. 21 is a schematic diagram of a visualization result of a LOD generation process. As shown in FIG. 21, a subjective example of LOD generation process based on distances is provided. Specifically, from the left to the right, the points in the first level are an outer contour representing a point cloud. With the increase of LODs, the detailed description of a point cloud gradually becomes clear.

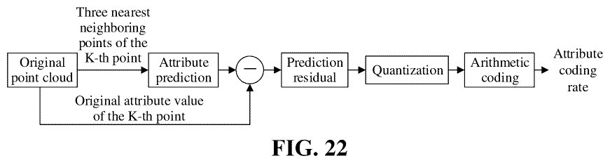

FIG. 22 is a flowchart of an encoding flow for an attribute prediction. As shown in FIG. 22, for the specific flow of G-PCC attribute prediction, for the original point cloud, first, three neighboring points of the K-th point are searched, and then attribute prediction is performed. Then the difference is calculated according to the attribute prediction value of the K-th point and the attribute original value of the K-th point, to obtain the prediction residual of the K-th point. Next, quantization and arithmetic coding are performed, to finally generate the attribute bit rate.

### (i) the Selection of an Optimal Predicted Value

After LOD construction is completed, according to the generation order of LODs, the three nearest neighbor points of the current point to be encoded are firstly found from the encoded data points. The reconstructed attribute values of the three nearest neighbor points are used as candidate prediction values of the current point to be encoded. Then, the optimal predicted value is selected from the candidate prediction values according to the Rate-Distortion Optimization (RDO). For example, when the attribute value of the point P2 in FIG. 20 is encoded, the predictor index of the attribute value of the first nearest neighbor point P4 is set to be 1; the predictor indexes of the attributes of the second nearest neighbor point P5 and the third nearest neighbor point P0 are set to be 2 and 3, respectively; and the predictor index of the weighted average of the point P0, point P5, and point P4 is set to be 0, as shown in Table 1. Finally, the optimal prediction variable is selected by using the RDO. The formula of the weighted average is as follows:

$${\hat{a}}_{i} = Round ( {\sum }_{j = 0}^{2} \frac{{\tilde{w}}_{i j}}{{\sum }_{j = 0}^{2} {\tilde{w}}_{i j}} {\tilde{a}}_{j} )$$

where \tilde{w}ᵢⱼ represents a spatial geometry weight from the nearest neighbor point j to the current point i:

$${\tilde{w}}_{i j} = \frac{1}{{( {x}_{i} - {x}_{i j} )}^{2} + {( {y}_{i} - {y}_{i j} )}^{2} + {( {z}_{i} - {z}_{i j} )}^{2}}$$

where âᵢ represents a predicted attribute value of the current point i, j represents the indexes of the three neighbor points, ãⱼ represents a reconstructed attribute value of the nearest neighbor point, xᵢ, yᵢ, zᵢ represent geometric position coordinates of the current point, and xᵢⱼ, yᵢⱼ, zᵢⱼ represent geometric coordinates of the nearest neighbor point j.

As an example, Table 1 provides example samples of candidate predictors for an attribute encoding.

TABLE 1

| Prediction Mode | Predicted value |
|---|---|
| 0 | weighted average of attributes of three |
| | nearest neighbor points |
| 1 | P4 (attribute value of the first |
| | nearest neighbor point) |
| 2 | P5 (attribute value of the second |
| | nearest neighbor point) |
| 3 | P0 (attribute value of the third |
| | nearest neighbor point) |

### (ii) Attribute Prediction Residual and Quantization

The predicted attribute value (âᵢ)_{i∈0 . . . k-1} (k is the total number of points in a point cloud) of the current point i is obtained through the above prediction. (aᵢ)_{i∈0 . . . k-1} is set as the original attribute value of the current point, then the attribute residual (rᵢ)_{i∈0 . . . k-1} is denoted as:

$${r}_{i} = {a}_{i} - {\hat{a}}_{i}$$

Further, the prediction residuals are quantified:

$${Q}_{i} = \frac{{r}_{i}}{Q s}$$

where Qᵢ represents the quantized attribute residual for the current point i, Qs is the quantization step (Qs) that may be calculated by using quantization parameters (QP) specified by the Common Test Condition (CTC).
   (iii) Reconstruction of Attribute Values at the Encoding End

The purpose of the reconstruction at the encoding end is for prediction of subsequent points. Before an attribute value is reconstructed, inverse quantization is required to be performed on a residual, and the inverse quantized residual is denoted as \hat{r}ᵢ:

$${\hat{r}}_{i} = {Q}_{i} \times Q s$$

\hat{r}ᵢ is added to the predicted value âᵢ to obtain the reconstructed value ãᵢ of the point i:

$${\tilde{a}}_{i} = {\hat{r}}_{i} + {\hat{a}}_{i}$$

At present, there are two categories of algorithms for attribute nearest-neighbor search based on LOD partitioning: intra nearest-neighbor search and inter nearest-neighbor search. Here, inter nearest-neighbor search algorithm is as follows. Intra nearest-neighbor search is classified into two algorithms: inter-level nearest-neighbor search and intra-level nearest-neighbor search.

### (i) Intra Nearest-Neighbor Search

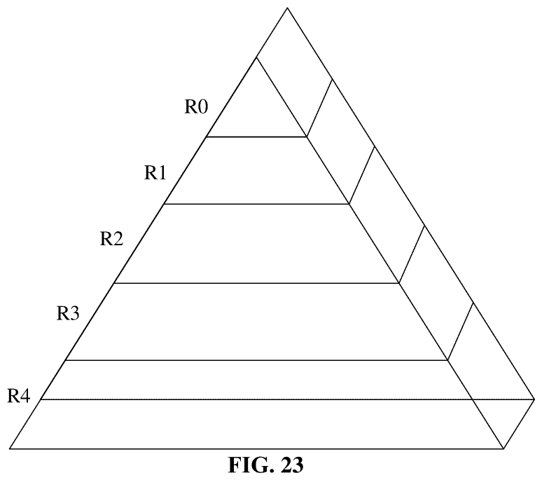

The intra nearest-neighbor search is classified into two algorithms: inter-level nearest-neighbor search and intra-level nearest-neighbor search. After LOD partitioning, a structure similar to a pyramid structure is obtained, as shown in FIG. 23.

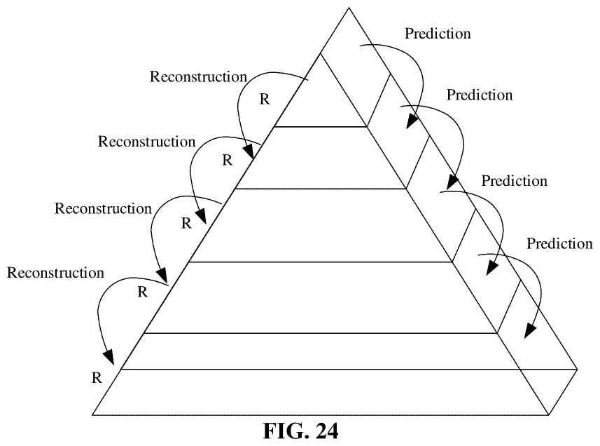

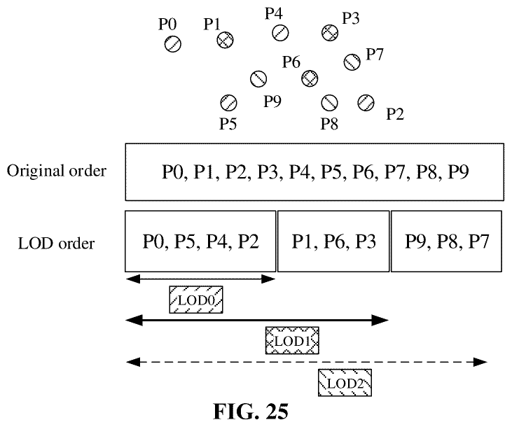

In a specific implementation, for the inter-level nearest-neighbor search, a pyramid structure is as shown in FIG. 24. FIG. 25 is a schematic diagram of a process of constructing an LOD for inter-level nearest neighbor search. As shown in FIG. 25, partitioning is performed based on geometric information to obtain different LODs which are LOD0, LOD1 and LOD2. Then, the points in the LOD0 may be used to predict the attributes of the points in the next LOD level in the process of the inter-level nearest-neighbor search.

The whole process of intra nearest-neighbor search may be introduced in detail below.

In the entire LOD partitioning, there are three sets, O(k), L(k) and I(k). Here, k is an index of a LOD in the LOD partitioning, I(k) is an input point set when the current LOD is partitioned. After the LOD partitioning, the set O(k) and the set L(k) are obtained, the set O(k) stores a set of sampling nodes, and L(k) is a set of points in the current LOD. That is to say, the whole process of LOD partitioning is as follows:
(1) Initialization

$$if k = 0 , ( k ) ← \{ \} , otherwise ( k ) ← L ( k - 1 )$$

$$O ( k ) ← \{ \}$$

(2) using the LOD partitioning algorithm to store the sampling points into O(k) and partition the remaining points into L(k)
(3) when the next iteration is performed: 1←O(k)

It is to be noted that since the process of the entire LOD partitioning is performed based on Morton codes, O(k), L(k) and I(k) store the indexes of Morton codes corresponding to points.

When inter-level nearest-neighbor search is performed, that is, the nearest-neighbor search is performed in the set O(k) for the points in the set L(k). The specific search algorithm is as follows.

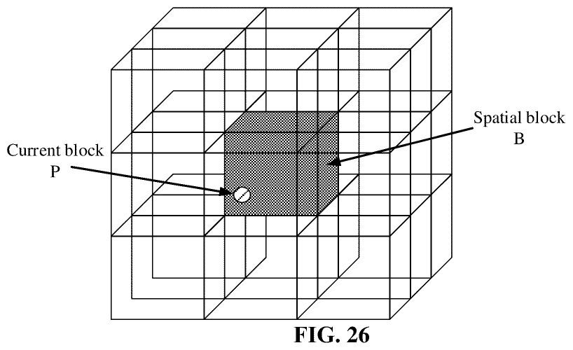

The nearest-neighbor search is performed based on a spatial relationship. When the current point P is predicted, the neighbor search is performed by using the parent block (i.e., the block B) corresponding to the point P, as shown in FIG. 26, and the points in the neighbor block that is coplanar and collinear with the current parent block are searched for to perform attribute prediction.

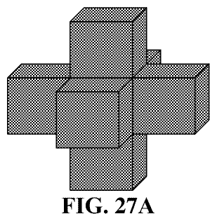

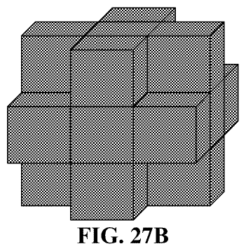

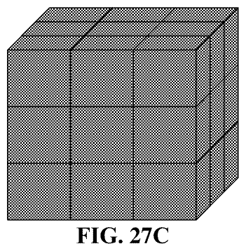

FIG. 27A shows a schematic diagram of a coplanar spatial relationship. There are 6 spatial blocks which have a relationship with the parent block. FIG. 27B shows a schematic diagram of a coplanar or collinear spatial relationship. There are 18 spatial blocks which have a relationship with the parent block. FIG. 27C shows a schematic diagram of a coplanar, collinear or co-point spatial relationship. There are 26 spatial blocks which have a relationship with the parent block.

Firstly, a corresponding spatial block is obtained by using the coordinates of the current point, and secondly, the nearest-neighbor search is performed on the previously encoded LOD, and search is performed in the spatial block that is coplanar, co-linear and co-point with the current block to obtain the N nearest neighbor points of the current point.

When the N nearest neighbor points of the current point are still not obtained after the coplanar, collinear or co-point nearest-neighbor search, the N nearest neighbor points of the current point may be obtained based on the fast search algorithm which is as follows.

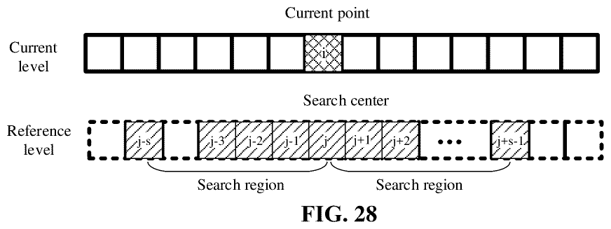

As shown in FIG. 28, when inter-level attribute prediction is performed, firstly, the Morton code corresponding to a current point to be encoded is obtained by using the geometric coordinates of the current point; secondly, the first reference point (j) having a Morton code larger than the Morton code of the current point is found from a reference frame based on the Morton code of the current point; and then, the nearest-neighbor search is performed within the range of [j−searchRange, j+searchRange].

Other specific algorithms for updating a nearest neighbor point are consistent with the inter nearest-neighbor search algorithm, so they will not be described in detail here. The specific algorithm may be mentioned in the inter nearest-neighbor search algorithm.

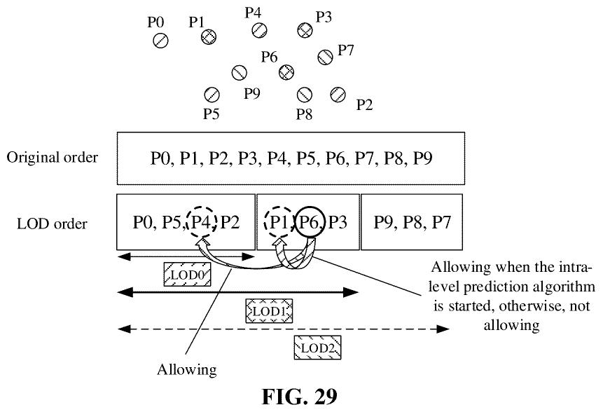

In another specific implementation, for intra-level nearest neighbor search, FIG. 29 is a schematic diagram of an LOD structure for attribute intra-level nearest-neighbor search. As shown in FIG. 29, when the intra-level prediction algorithm is started, that is, the syntax element EnableRefferingSameLoD=1, the nearest neighbor search may be allowed within the level. For example, for the LOD1, the nearest neighbor point of the current point P6 may be P1, and other levels are not allowed for the nearest neighbor search. If the syntax element EnableRefferingSameLoD=0, then inter-level search is allowed in other levels. For example, for the LOD1, the nearest neighbor point of the current point P6 may be P4. That is to say, when the intra-level prediction algorithm is turned on, the nearest neighbor search will be performed in the encoded point set within the same LOD to obtain the N nearest neighbor of the current point (the inter-level nearest neighbor search will also be performed).

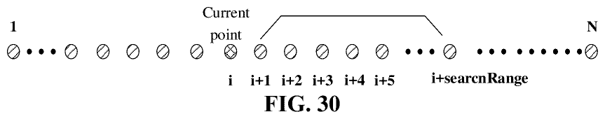

When intra-level attribute prediction is performed, the nearest-neighbor search may be performed based on the fast search algorithm. The specific algorithm is shown in FIG. 30. The current point is represented by a grid, it is assumed that the index of the Morton code of a current point is i, the nearest-neighbor search may be performed in a range of [i+1, i+searchRange]. The specific nearest-neighbor search algorithm is consistent with the inter block-based fast search algorithm, and will not be described in detail here.

### (ii) Inter Nearest Neighbor Search

FIG. 28 is a schematic diagram of an attribute inter prediction. As shown in FIG. 28, when attribute inter prediction is performed, firstly, the Morton code corresponding to a current point to be encoded is obtained by using the geometric coordinates of the current point; secondly, the first reference point (j) having a Morton code larger than the Morton code of the current point is found from a reference frame based on the Morton code of the current point; and then, the nearest neighbor search is performed within the range of [j-searchRange, j+searchRange].

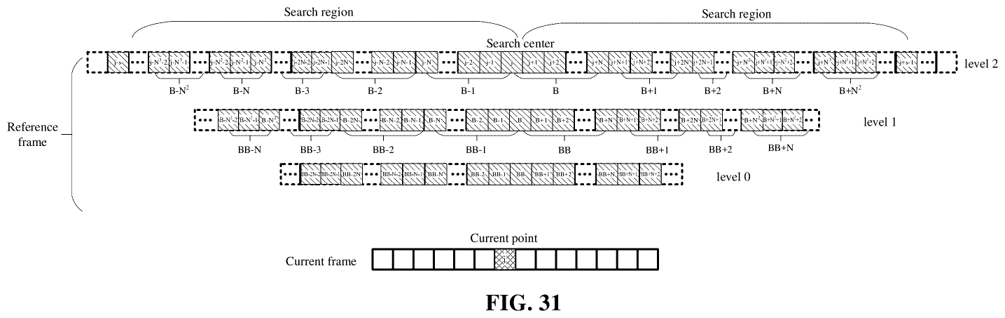

At present, When the intra nearest neighbor search and the inter nearest neighbor search are performed, the neighborhood search is performed on a block basis, as shown in FIG. 31 for details. As shown in FIG. 31, when the neighborhood search is performed for a current point (having the index i of the Morton code), the points in a reference frame are firstly partitioned into N (N=3) levels based on the Morton codes. The specific partitioning algorithm is as follows:

For a first level, it is assumed that the points in the reference frame is numPoints, and every M (M=2⁵=32) points among the points in the reference frame may be firstly partitioned into one block.

For a second level, based on the first level, similarly, every M (M=2⁵=32) blocks among the blocks of the first level are also partitioned into one block in the order of Morton codes.

For a third level, based on the second level, similarly, every M (M=2⁵=32) blocks among the blocks of the first level are also partitioned into one block in the order of Morton codes.

Finally, the prediction structure shown in FIG. 31 is obtained.

Attribute prediction is performed based on the prediction structure as shown in FIG. 31. It is assumed that the index of the Morton code of a current point to be encoded is i, firstly, the first point having a Morton code greater than or equal to the Morton code of the current point is obtained from a reference frame, and has the index j. Secondly, the block index of the reference point is calculated based on j, and the specific calculation method is as follows:

For the first level, BucketSize 0=2⁵=32.
For the second level, BucketSize_1=2⁵=32×BucketSize_0=1024.
For the third level, BucketSize_2=2⁵=32×BucketSize_1=32768.

It is assumed that the reference range in the prediction frame of the current point is [j−searchRange, j+searchRange], the starting index of the third level is calculated by using j−searchRange, and the termination index of the third level is calculated by using j+searchRange. Secondly, it is firstly determined in the blocks of the third level whether the nearest-neighbor search is required to be performed for some blocks of the second level; and secondly, at the second level, it is determined whether the search is required to be performed for each block of the first level. If the nearest-neighbor search is required to be performed for some blocks of the first level, the determination may be performed on each of the some blocks of the first level to update the nearest neighbor points.

The algorithm of calculating a block based on an index will be introduced below. It is assumed that the Morton code index corresponding to the current point is index, then the index of the corresponding block in the third level is:

$$idx\_ 2 = index / BucketSize\_ 2$$

After the index idx_2 of the block of the third level is obtained, the starting index and the end index of the blocks, corresponding to the current block, in the second level may be obtained by using idx_2:

$$startIdx 1 - idx\_ 2 \times BucketSize\_ 1 ;$$

$$endIdx = idx\_ 2 \times BucketSize\_ 1 + BucketSize\_ 1 - 1.$$

Similarly, based on the same algorithm, the index of block of the first level is obtained based on the index of the block of the second level.

When nearest-neighbor search is performed based on blocks, it may be firstly determined whether the nearest-neighbor search is required to be performed for a current block, i.e., the nearest-neighbor search of the block is filtered. Each spatial block may be obtained by using two variables: minPos and maxPos. minPos represents the minimum value of the block, and maxPos represents the maximum value of the block.

It is assumed that the farthest point among the searched N nearest neighbor points has a distance Dist from the current point, the coordinates of a point to be encoded are (x, y, z), and a current block is expressed as (minPos, maxPos), where minPos is the minimum value of the bounding box in three dimensions and maxPos is the maximum value of the bounding box in three dimensions, then, the distance D between the current point and the bounding box is calculated as follows:

$$int dx = int ( std : : max ( std : : max ( min Po s [ 0 ] - point [ 0 ] , 0 , point [ 0 ] - max Po s [ 0 ] ) ) ;$$

$$int dy = in t ( std : : max ( std = : : max ( i n P o s [ 1 ] - point [ 1 ] , 0 ) , point [ 1 ] - max Po s [ 1 ] ) ) ; \\$$

$$int dz = int ( std : : max ( std : : max ( min Po s [ 2 ] - point [ 2 ] , 0 ) , point [ 2 ] - max Po s [ 2 ] ) ) ;$$

$$D = dx + dy + dz ;$$

When D is less than or equal to Dist, the points in the current block will be traversed.

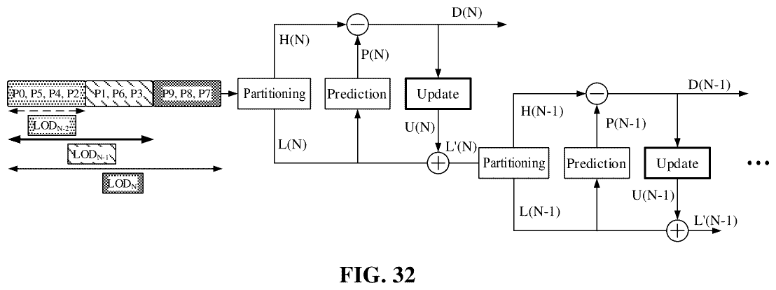

FIG. 32 is a schematic diagram of an encoding flow of lifting transform. In the lifting transform, predictive encoding is also performed on point-cloud attributes based on LOD. The lifting transform is different from the predictive transform in that LOD is firstly partitioned into high levels and low levels, prediction proceeds in the inverse order of LOD generation, and an update operator is introduced during the prediction to update quantization weights for points in low LOD, thereby improving the prediction accuracy. This is because the attribute values of the points in low LOD will be frequently used to predict the attribute values of the points in high LOD, and the points in low LOD should have greater influence.

### Step 1: Splitting

Splitting is to partition full LODs into low LOD L(N) and high LOD H(N). If a point cloud has three LODs, i.e., (LODₜ)_{t=0,1,2}, after splitting, LOD₂ as high LOD is denoted as H(N), and (LODₜ)_{t=0, 1} as low LODs are denoted as L(N).

### Step 2: Prediction

For a point in the high LOD, the attribute information of the nearest neighbor point selected from the low LOD is used as the predicted attribute value P(N) of the current point to be encoded, and the prediction residual D(N) is denoted as:

$$D ( N ) = H ( N ) - P ( N )$$

### Step 3: Updating

The attribute prediction residual D(N) in the high LOD is updated to obtain U(N), and the attribute value of the point in the low LOD may be lifted by using U(N), as shown in the following formula:

$${L}^{′} ( N ) = L ( N ) + U ( N )$$

The above process may be iterated down to the lowest LOD in the order of LODs from high to low.

Because the LOD-based prediction scheme makes the points in the low LOD have greater influence, in the transform scheme based on lifting wavelet transform, the quantization weight is introduced; and a prediction residual is updated according to the prediction residual D(N) and the distance between a point to be predicted and a neighbor point; and finally, the quantization weight in the transform process is used to adaptively quantize the prediction residual. It is to be noted that the quantization weight value for each point may be determined by geometric reconstruction at the decoding end, therefore, the quantization weight is not required to be encoded.

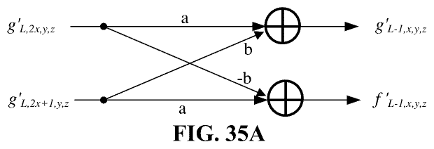

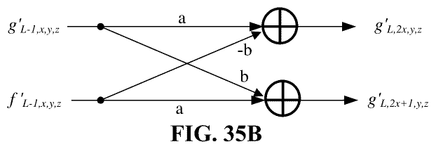

The RAHT is a kind of Haar wavelet transform, which may transform the attribute information of a point cloud from the spatial domain to the frequency domain, thereby reducing the correlation between attributes of the point cloud. FIG. 35 is a schematic diagram of a process of RAHT along three directions x, y and z. As shown in FIG. 35, according to the octree structure, the transform is performed, in a manner from bottom to top, on the nodes in each level respectively in three dimensions x, y and z, until the transform is iterated to the root node of the octree.

### (c) Regional Adaptive Hierarchical Transform

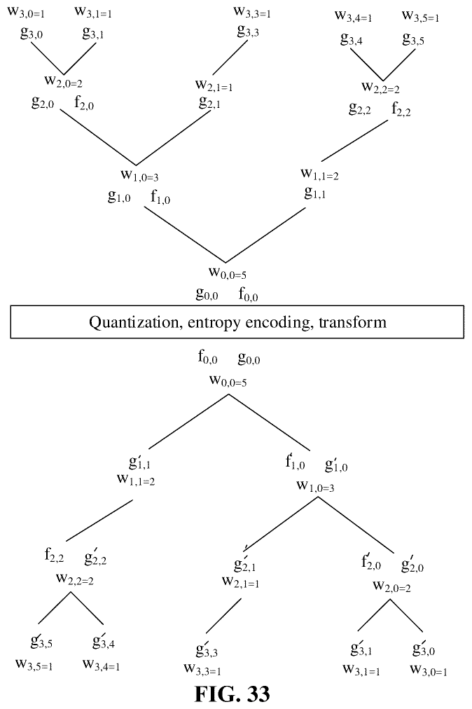

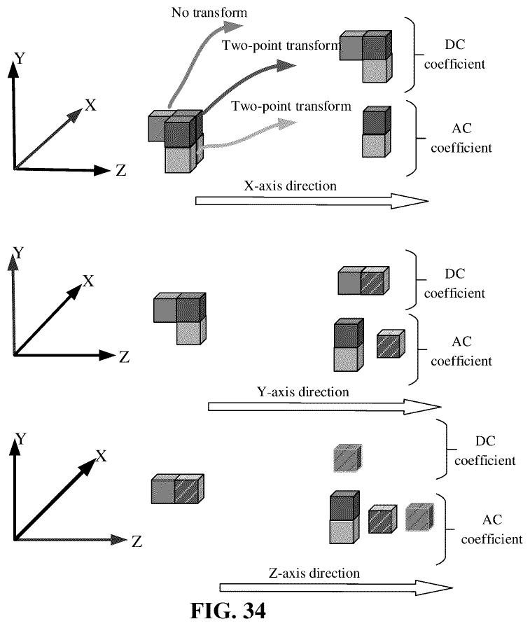

Region Adaptive Hierarchical Transform (RAHT) is a kind of Haar wavelet transform, which can transform point cloud attribute information from spatial domain to frequency domain, further reducing the correlation between point cloud attributes. The main idea is to transform the nodes of each level in the three dimensions X, Y, and Z in a bottom-up way according to the octree structure (as shown in FIG. 34), and iterate until the root node of the octree. As shown in FIG. 33, the basic idea is to perform wavelet transform based on the hierarchical structure of the octree, associate attribute information with octree nodes, recursively transform the attributes of the occupied nodes in the same parent node in a bottom-up manner, and transform the nodes of each level in three dimensions X, Y, and Z until the transform is performed on the root node of the octree. In the process of hierarchical transformation, the low-pass/low-frequency (DC) coefficients obtained after the transformation of nodes in the same level are transferred to the nodes in the next level for continued transformation, and all the high-pass/high-frequency (AC) coefficients can be encoded by arithmetic encoder.

During the transformation process, the transformed DC coefficients (DC components) of the same level nodes will be transferred to the previous level for continued transformation, and the transformed AC coefficients (AC components) of each level will be quantized and encoded. The main transformation process will be described below.

FIG. 35A is a schematic diagram of a process of a forward RAHT, and FIG. 35B is a schematic diagram of a process of an inverse RAHT. For the transformation and inverse transformation processes corresponding to RAHT, it is assumed that

$${g}_{L , 2 x , y , z}^{′} and {g}_{L , 2 x + 1 , y , z}^{′}$$

are two attribute DC coefficients for nearest neighbors that are nearest neighbors to each other in the L level. After the linear transformation, the information of the L-1 level is AC coefficient

$${f}_{L - 1 , x , y , z}^{′}$$

and DC coefficient

$${g}_{L - 1 , x , y , z}^{′} .$$

Then, transformation will not performed on

$${f}_{L - 1 , x , y , z}^{′}$$

and quantization and encoding may be performed directly on

$${f}_{L - 1 , x , y , z}^{′} .$$

### For

$${g}_{L - 1 , x , y , z}^{′} ,$$

it will continue to find the nearest neighbor to perform transformation. If the nearest neighbor cannot be found,

$${g}_{L - 1 , x , y , z}^{′}$$

may be directly transferred to the L-2 level. That is, the RAHT is only valid for nodes with neighbor points, and for nodes without neighbor points, it will be directly transferred to the upper level. In the above transformation process, the weights corresponding to

$${g}_{L , 2 x , y , z}^{′} and {g}_{L , 2 x + 2 , y , z}^{′}$$

(the number of non-empty child nodes in the node) are

$${w}_{L , 2 x , y , z}^{′} and {w}_{L , 2 x + 1 , y , z}^{′}$$

*abbreviated as

$${w}_{0}^{′} and {w}_{1}^{′}$$

respectively, and the weights for

$${g}_{L - 1 , x , y , z}^{′} are {w}_{L - 1 , x , y , z}^{′} ,$$

then the general transformation formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

where T_{w0,w1} is the transformation matrix:

$${T}_{w 0 , w 1} = \frac{1}{\sqrt{{w}_{0}^{′} + {w}_{1}^{′}}} [ \begin{matrix}\sqrt{{w}_{0}^{′}} & \sqrt{{w}_{1}^{′}} \\ - \sqrt{{w}_{1}^{′}} & \sqrt{{w}_{0}^{′}}\end{matrix} ]$$

The transformation matrix will be updated adaptively with the weights corresponding to each point. The above process will be iteratively updated according to the partition structure of the octree until the root node of the octree.

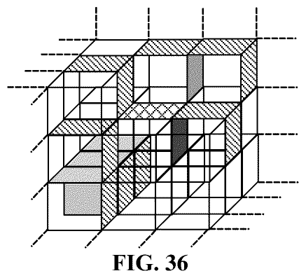

In a specific implementation, for region-adaptive hierarchical intra prediction transform coding, prediction may be performed on the basis of RAHT coding. As shown in FIG. 33, based on the sequence of levels of the octree, the RAHT attribute transformation is performed on nodes at the voxel levels continuously until the root node, thereby completing the hierarchical transformation coding of the entire attribute. In prediction transform coding, attribute prediction transform coding is also performed based on the hierarchical order of the octree, but the transformation is continuously performed from the root node to the voxel level. In the process of each RAHT attribute transform, attribute prediction transform coding is performed based on 2× 2× 2 blocks. Specifically, as shown in FIG. 36, it can be seen that the a block filled with a grid is the current block to be encoded, and blocks filled with oblique lines are some neighborhood blocks that are coplanar or collinear with the current block to be encoded. The attributes of the current block are normalized in the following manner:

$${A}_{node} = {\sum }_{p ∈ node} attribute ( p ) ; \\ {w}_{node} = {\sum }_{p ∈ node} 1 = \{ p ∈ node \} ; \\ {a}_{node} = {A}_{node} / {w}_{node}$$

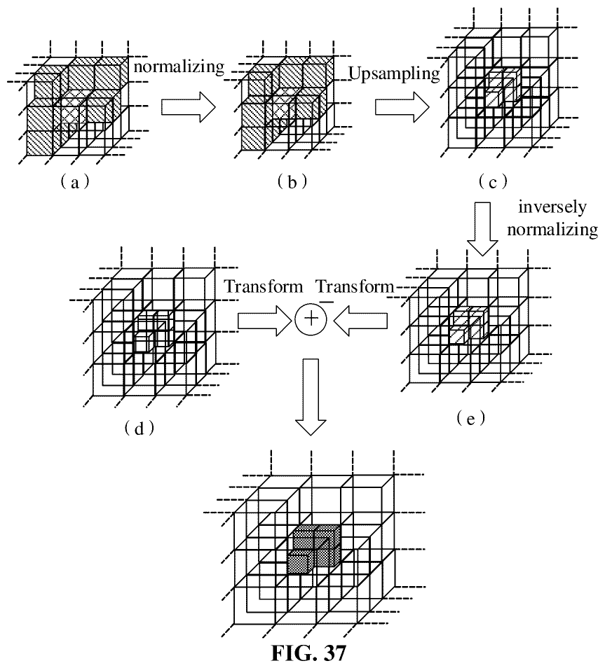

First, the attribute of the current block may be obtained by using the attributes of the points contained in the current block, namely: A_{node}. By simply adding the attributes of the points contained in the current block, and then a normalizing process is performed by using the attributes of the current block and the number of points in the current block, to obtain the mean value a_{node} of the attributes of the current block. The mean value of the attributes of the current block is used to perform attribute transformation coding. The specific encoding process is shown in FIG. 37.

As shown in FIG. 37, the overall flow of RAHT attribute prediction transform coding is shown here. (a) is the current block and some coplanar and collinear neighborhood blocks, (b) is the normalized block, (c) is the upsampled block, (d) is the attribute of the current block, (e) is the attribute of the prediction block obtained by performing linear weighted fitting using the neighborhood attribute of the current block, finally the attribute transformation are performed on the attribute of the current block and the attribute of the prediction block, respectively, to DC and AC coefficients, and the predictive code is performed on the AC coefficients.

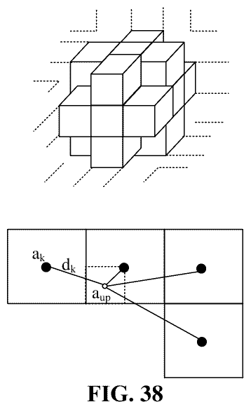

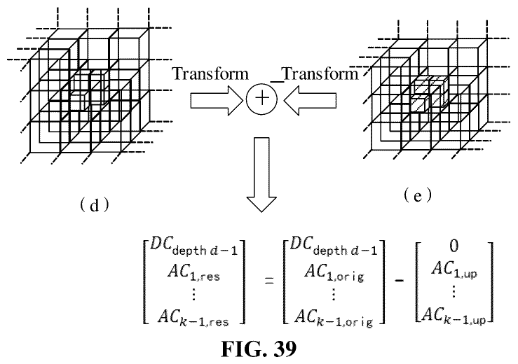

The prediction attribute of the current block can be obtained by performing a linear fitting as shown in FIG. 38. As shown in FIG. 38, first, 19 neighborhood blocks of the current block are obtained, secondly, linear weighting prediction is performed on the attribute of each sub-block of the current block by using the spatial geometric distance between the neighborhood block and the sub-block, and finally the block attribute obtained by performing linear weighting prediction is used to transform. The specific attribute transformation is shown in FIG. 39.

In FIG. 39, (d) represents the original value of the attribute, and the corresponding attribute transformation coefficients are as follows:

$$[ \begin{matrix}* \\ {AC}_{1 , orig} \\ ⋮ \\ {AC}_{k ‐ 1 , orig}\end{matrix} ] = {T}_{node} [ \begin{matrix}{A}_{1} , orig / \sqrt{{w}_{1}} \\ ⋮ \\ {A}_{k , orig} / \sqrt{{w}_{k}}\end{matrix} ]$$

(e) represents the attribute prediction value, and the corresponding attribute transformation coefficients are as follows:

$$[ \begin{matrix}* \\ {AC}_{1 , up} \\ ⋮ \\ {AC}_{k ‐ 1 , up}\end{matrix} ] = {T}_{node} [ \begin{matrix}{A}_{1 , up} / \sqrt{{w}_{1}} \\ ⋮ \\ {A}_{k , up} / \sqrt{{w}_{k}}\end{matrix} ]$$

The subtraction operation is performed according to the original value of the attribute and the prediction value of the attribute, to obtain the prediction residual as follows:

$$[ \begin{matrix}{DC}_{depth d - 1} \\ {AC}_{1 , res} \\ ⋮ \\ {AC}_{k - 1 , res}\end{matrix} ] = [ \begin{matrix}{DC}_{depth d - 1} \\ {AC}_{1 , orig} \\ ⋮ \\ {AC}_{k - 1 , orig}\end{matrix} ] - [ \begin{matrix}0 \\ {AC}_{1 , up} \\ ⋮ \\ {AC}_{k - 1 , up}\end{matrix} ]$$

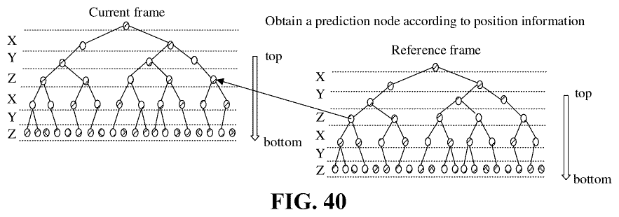

In another specific implementation, for region adaptive hierarchical inter predictive transform coding, in G-PCC attribute inter prediction, the process is similar to that of intra predictive coding. Firstly, RAHT attribute transformation coding structure is constructed based on geometric information, that is, the transformation is continuously transformed from the voxel level until the root node is obtained, thus completing the hierarchical transformation coding for the whole attribute. In this manner, an intra coding structure and an inter attribute coding structure are constructed, as shown in FIG. 40.

As shown in FIG. 40, firstly, the co-location prediction node of the node to be coded is obtained from the reference frame by using the geometric information of the current node to be coded, and secondly, the prediction attribute of the current node to be coded is obtained by using the geometric information and attribute information of the reference node.

The attribute prediction value of the current node to be coded is obtained according to the following two different ways:
(1) The inter prediction node of the current node is valid. That is, if the co-location node exists, the attribute of the prediction node is directly taken as the attribute prediction value of the current node to be coded;
(2) The inter prediction node of the current node is invalid. That is, if the co-location node does not exist, the attribute prediction value of the adjacent node in the frame is used as the attribute prediction value of the node to be coded.

Finally, the obtained attribute prediction value is used to predict the attribute of the current node to be coded. Therefore the predictive coding for the entire attribute is completed.

At present, in the common RAHT attribute transform coding of G-PCC, coding and decoding are performed in the order from a root node to a child node. Firstly, the geometric information of the node of the current level is used to recover the child node of the current level in the order of Z, Y and X. Secondly, the predictive decoding is performed on the attributes of the node of the current level by using the reconstructed attributes of the parent node level, to recover the attributes of the node of the current level until it is transformed to the child node, that is, the voxel level. In common G-PCC, if the number of nodes in the current level is exactly the same as the number of child nodes of the current level, it indicates that each node in the current level has only one child node. That is, AC coefficients may not be generated for the current level. However, in common coding schemes, the nodes in the current level still need to be transformed and predicted in turn, which will increase the complexity of RAHT attribute transform encoding and decoding, and introduce a redundant operation.

In order to solve the above problems, in embodiments of the present application, a first node number of nodes of a current level and a second node number of child nodes corresponding to the nodes of the current level are determined, the first node number and the second node number are used to determine whether to perform RAHT on the nodes of the current level; the reconstructed attribute values of the child nodes corresponding to the nodes of the current level is determined according to the first node number and the second node number. Thus, in the embodiments of the present application, when predicting the attribute information, the first node number of the nodes of the current level and the second node number of the corresponding child nodes can be obtained first. Therefore, in the process of reconstructing the attribute information of the child nodes corresponding to the nodes of the current level based on the first node number and the second node number, it is possible to determine whether or not the RAHT of the current level is skipped according to the first node number and the second node number, thereby effectively removing attribute redundancy, improving the attribute encoding and decoding efficiency for the point cloud, and further improving the encoding and decoding performance for the point cloud.

That is, the embodiments of the present application propose an encoding method of skipping an encoding level, and by adaptively determining whether the encoding for the current level can be skipped by using the number of nodes of the current level and the number of child nodes, the time complexity of encoding and decoding can be reduced on the premise of ensuring that the efficiency of encoding and decoding remains unchanged.

Hereinafter, the embodiments of the present application will be described in detail with reference to the accompanying drawings.

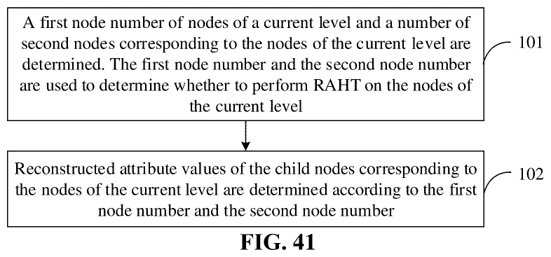

In an embodiment of the present application, reference is made to FIG. 41, which shows a schematic flowchart of a decoding method according to the embodiment of the present application. As shown in FIG. 41, the method may include Operations 101-102.

At Operation 101, a first node number of nodes of a current level and a number of second nodes corresponding to the nodes of the current level are determined. The first node number and the second node number are used to determine whether to perform RAHT on the nodes of the current level.

In the embodiments of the present application, the first node number of the nodes of the current level may be determined first, and the second node number corresponding to the nodes of the current level may be determined at the same time.

It should be noted that the decoding method according to the embodiments of the present application specifically refers to a point cloud decoding method, and the method may be applied to a point cloud decoder (also referred to as a “decoder”).

Accordingly, in the embodiments of the present application, the current level may be a RAHT level to be decoded.

Further, in the embodiments of the present application, it is necessary to construct the RAHT attribute transformation encoding structure based on the geometric information of the points in the point cloud first. Specifically, the transformation can be continuously performed from the voxel level until the root node is obtained, thereby completing the hierarchical transformation encoding of the entire attribute, and then the RAHT attribute transformation encoding structure including at least one RAHT level may be obtained.

It should be noted that, in the embodiments of the present application, the RAHT attribute transformation may be performed based on the order of the octree hierarchy. In the process of constructing the RAHT attribute transformation coding structure, based on the hierarchical order of the octree, the transformation is continuously performed starting from the voxel level until the root node is obtained. In the process of attribute prediction transformation coding, it can also be based on the hierarchical order of octree, but the transformation is continuously performed from the root node to the voxel level.

It can be understood that in the embodiments of the present application, a level obtained by sequentially downsampling along a preset direction, such as the Z direction, the Y direction, and the X direction, may be defined as a RAHT level, such as a current level (layer).

It should be noted that, in the embodiments of the present application, for the current level, the current level may include at least one point. When the current level is decoded, the at least one point in the current level may be used as a node to be decoded in the current level.

Further, in the embodiment of the present application, each point in the current level corresponds to one piece of geometric information and one piece of attribute information; among them, the geometric information represents the spatial relationship of the point, and the attribute information represents the related information of the attributes of the point.

Here, the attribute information may be color information, reflectivity, or other attributes, which is not particularly limited in the embodiments of the present application. Here, when the attribute information is color information, specifically, the attribute information may be color information in any color space. For example, the attribute information may be color information in the RGB space, color information in the YUV space, color information in the YCbCr space, or the like, which is not specifically limited in the embodiments of the present application.

It should be noted that, in the embodiments of the present application, when performing RAHT transformation encoding, first, attribute transformation and the inverse transformation for the nodes at the non-voxel level are completed, and second, the transformation for the nodes at the voxel level is completed, because there may be a phenomenon of repeated points in the point cloud.

Accordingly, in the embodiments of the present application, if the nodes of the current level are at a non-voxel level, the first node number may represent the number of occupied nodes of the current level. The second node number may then represent the number of occupied child nodes in the nodes of the current level.

Accordingly, in the embodiments of the present application, if the nodes of the current level are at the voxel level, the first node number may represent the number of occupied nodes of the current level. The second node number may then represent the number of nodes to be decoded.

That is, in the embodiments of the present application, the first node number is the number of valid nodes (i.e. occupied nodes) of the current level. For nodes at the non-voxel level, the second node number is the number of valid child nodes of the current level (i.e. occupied child node). For nodes at the voxel level, the second node number is the number of nodes to be decoded.

Further, in the embodiments of the present application, the geometric information of the nodes of the current level may be determined first. Then, the child nodes corresponding to the nodes of the current level and the second node number are determined according to the geometric information.

It should be noted that, in the embodiments of the present application, for a current node of the current level, when the corresponding child node is determined by using the geometric information of the current node, the geometric information of the current node can be used to perform up-sampling to obtain the occupied child node in the current node (the number of child nodes is N, and the maximum value of Nis 8).

For example, in some embodiments, when encoding or decoding is performed on the attribute information of the nodes of the current level, the number of nodes of the current level, that is, the first node number, may be obtained first. After the child nodes of the nodes of the current level is recovered by using the geometric information of the nodes of the current level, the number of child nodes of the nodes of the current level, that is, the second node number, may be obtained.

Further, in the embodiments of the present application, the bitstream may be decoded first, to determine identification information of a prediction mode. If a value of the identification information of the prediction mode is a first value, it is determined that the prediction mode corresponding to the nodes of the current level is a preset prediction mode. If the value of the identification information of the prediction mode is a second value, it is determined that the prediction mode corresponding to the nodes of the current level is not the preset intra prediction mode.

It is to be understood that, in the embodiments of the present application, identification information of a prediction mode may be used to indicate whether or not the attribute information of the nodes of the current level is predicted in the preset prediction mode.

It should be noted that, in the embodiments of the present application, the preset prediction mode may be a prediction mode in which a coding level (RAHT level) is skipped selectively. Here, based on the preset prediction mode, it is possible to select whether or not to skip the current level according to the determined first node number and the second node number corresponding to the current level.

It should be noted that in the embodiments of the present application, the first value and the second value are different, and the first value and the second value may be in a parameter form or a numeric value form.

Exemplarily, in some embodiments, taking the first value set to 1 and the second value set to 0 as an example, the bitstream is decoded to determine the value of the identification information of the prediction mode. If the value of the identification information of the prediction mode is 1, it is determined that the prediction mode corresponding to the nodes of the current level is the preset prediction mode, and the first node number and the second node number corresponding to the nodes of the current level may be further determined according to the above-described method. If the value of the identification information of the prediction mode is 0, it can be determined that the prediction mode corresponding to the nodes of the current level is not the preset prediction mode, and the prediction processing may be performed on the attribute information of the current level according to a common intra prediction method or an inter prediction method.

That is, in the embodiments of the present application, if the value of the identification information of the prediction mode determined by decoding the bitstream is the first value, that is, it is determined that the prediction mode corresponding to the current level is the preset prediction mode, the process of determining the first node number and the second node number, that is, the process of operation 101, may be executed.

It should be noted that, in the embodiments of the present application, the first node number and the second node number may be used to determine whether or not to perform RAHT on the nodes of the current level. That is, after the first node number and the second node number are determined, it may be determined whether or not the subsequent processing flow of performing RAHT on the nodes of the current level is skipped according to the first node number and the second node number.

At Operation 102, reconstructed attribute values of the child nodes corresponding to the nodes of the current level are determined according to the first node number and the second node number.

In the embodiments of the present application, after determining the first node number and the second node number corresponding to the nodes of the current level, the reconstructed attribute values of the child nodes corresponding to the nodes of the current level may be further determined according to the first node number and the second node number.

Further, in the embodiments of the present application, after determining the first node number and the second node number corresponding to the nodes of the determined current level, whether the encoding or decoding for the attribute information of the coding level (current level) is skipped may be determined by using the first node number and the second node number corresponding to the nodes of the current level.

It may be understood that, in the embodiments of the present application, since the RAHT is only valid for nodes having neighbor points, if the number of nodes in the current level is completely consistent with the number of child nodes of the nodes in the current level, it may indicate that each node in the current level has only one child node. In this case, AC coefficients (high-frequency coefficients) may not be generated for the current level, so it is possible to skip the processes such as transformation and prediction, sequentially performed on the nodes in the current level.

That is, in the embodiments of the present application, by using the number of nodes of the current level and the number of child nodes of the current level, it is possible to adaptively determine whether encoding and decoding for the current level may be skipped. The key to determining whether to skip the encoding and decoding processing for the current level is whether the number of nodes in the current level is the same as the number of child nodes, that is, whether the first node number and the second node number are the same.

Further, in the embodiments of the present application, when the reconstructed attribute values of the child node corresponding to the node of the current level is determined according to the first node number and the second node number, if the first node number and the second node number are the same, the reconstructed attribute values of the nodes of the current level are determined as the reconstructed attribute values of the child nodes corresponding to the nodes of the current level.

It may be understood that, in the embodiments of the present application, if the first node number and the second node number corresponding to the nodes of the current level are the same, that is, it can be determined that the number of nodes of the current level is the same as the number of child nodes corresponding to the nodes of the current level, then it may be considered that only one child node corresponds to each node of the current level.

Accordingly, in the embodiments of the present application, since the RAHT is valid only for nodes having neighbor points, in the process of RAHT attribute transformation, if each node of the current level corresponds to only one child node, it can be considered that AC coefficients may not be generated for the current level. Therefore, the processes such as transformation and prediction may not be sequentially performed on the nodes of the current level, that is, the processes for the current level are skipped, and at this time, the current level can be used as a skip decoding level.

Accordingly, in the embodiments of the present application, if it is determined that the first node number and the second node number corresponding to the nodes of the current level are the same, that is, it is determined that the current level is a skip decoding level, then it is possible to skip the processes such as transformation and prediction sequentially performed on the nodes of the current level. Instead, the reconstructed attribute values of the nodes of the current level may be directly determined as the reconstructed attribute values of the child nodes corresponding to the nodes of the current level.

That is, in the embodiments of the present application, in the process of RAHT attribute transformation, if each node of the current level has only one child node, it is possible to select not to sequentially perform the processes such as transformation and prediction on the nodes of the current level, thereby reducing the complexity of RAHT attribute transformation encoding and decoding.

Further, in the present embodiments of the present application, when the reconstructed attribute values of the child nodes corresponding to the nodes of the current level are determined according to the first node number and the second node number, if the first node number and the second node number are the same, and the current level is determined to be a skip decoding level, it may skip the current level to the next level, and the prediction processing of the attribute information of may be directly performed on the next level according to the preset prediction mode.

Accordingly, in the embodiments of the present application, based on the preset prediction mode, for the child nodes of the nodes of the current level, a third node number of child nodes in a next level corresponding to the child nodes may be determined first. Then, the reconstructed attribute values of the child nodes in the next level corresponding to the child nodes are determined according to the second node number and the third node number.

It can be understood that, in the embodiments of the present application, if the child nodes of the nodes of the current level are nodes at a non-voxel level, the third node number may be the number of effective child nodes in the next level (that is, the child node occupied in the next level) of the child nodes of the nodes in the current level. If the child nodes of the nodes of the current level are nodes at a voxel level, the second node number may be the number of nodes to be decoded.

It should be noted that, in the embodiments of the present application, based on the preset prediction mode, after the second node number and the third node number are determined, the second node number and the third node number may be used to determine whether or not to skip encoding and decoding for attribute information of the encoding level (the next level of the current level).

For example, in some embodiments, if the second node number and the third node number are the same, sequentially performing the processes such as transformation and prediction may not be performed on the child nodes of the nodes of the current level, that is, the processing for the child nodes of the current level may be skipped, and the reconstructed attribute values of the child nodes corresponding to the nodes of the current level may be determined directly as the reconstructed attribute values of the child nodes in the next level of the child nodes corresponding to the nodes of the current level.

Further, in the embodiments of the present application, when the reconstructed attribute values of the child nodes corresponding to the nodes of the current level are determined according to the first node number and the second node number, if the first node number and the second node number corresponding to the nodes of the current level are different, that is, it may be determined that the number of nodes of the current level is different from the number of child nodes corresponding to the node of the current level. At this time, AC coefficients may be sill generated for the current level. Therefore, processes such as transformation and prediction may be continuously and sequentially performed for the nodes of the current level, the processes for the nodes of the current level may not be skipped. At this time, the current level may be regarded as a non-skip decoding level.

Accordingly, in the embodiments of the present application, if it is determined that the first node number and the second node number corresponding to the nodes of the current level are different, that is, it is determined that the current level is a non-skip decoding level, the attribute prediction values of the child nodes corresponding to the nodes of the current level may be determined according to the nodes of the current level. Then RAHT may be performed based on the attribute prediction values of the child nodes to determine the reconstructed values of the high-frequency coefficients and the low-frequency coefficients corresponding to the nodes of the current level. Next, inverse RAHT is performed based on the low-frequency coefficients and the reconstructed values of the high-frequency coefficients to determine the reconstructed attribute values of child nodes.

Further, in the embodiments of the present application, when the attribute prediction values of the child nodes corresponding to the nodes of the current level are determined according to the nodes of the current level, a neighboring nodes corresponding to the nodes of the current level may be determined first. Then, the attribute prediction values of the child nodes corresponding to the nodes of the current level are determined according to the reconstructed attribute value corresponding to the neighboring node and the relative distance parameter.

It should be noted that, in the embodiments of the present application, the relative distance parameter corresponding to the neighboring node may represent the spatial geometric distance between the child nodes corresponding to the nodes of the current level and the corresponding neighboring node.

Exemplarily, in some embodiments, for a current node of a current level, the current node includes two child nodes, a child node 1 and a child node 2, the relative distance parameter between the current node and the neighboring node may include a spatial geometric distance between the child node 1 and the neighboring node, and may also include a spatial geometric distance between the child node 2 and the neighboring node.

For example, in some embodiments, when the attribute prediction values of the child nodes corresponding to the nodes of the current level are determined according to the nodes of the current level, for the current node of the current level, the reconstructed attribute (reconstructed attribute values) of the neighborhood node (neighboring node) of the current node and the spatial geometric distance between each neighborhood node and the child node of the current node may be used to perform linear fitting, to obtain the predicted attribute value of each child node of the current node finally.

Exemplarily, in some embodiments, for the current node of the current level, 19 neighboring nodes of the current node may be determined first. Then, the attribute of each child node may be predicted in a way of linear weighting using the spatial geometric distances between the neighboring nodes and the child node of the current node, to finally obtain the attribute prediction value of the child node.

Further, in the embodiments of the present application, when the RAHT is performed based on the attribute prediction values of the child nodes to determine the low-frequency coefficients and the reconstructed values of the high-frequency coefficients corresponding to the nodes of the current level, the RAHT may be performed based on the attribute prediction values of the child nodes, to determine the low-frequency coefficients and the prediction values of the high-frequency coefficients corresponding to the nodes of the current level. Then, the reconstructed values of the high-frequency coefficients corresponding to the nodes of the current level are determined according to the prediction values of the high-frequency coefficients.

It can be understood that, in the embodiments of the present application, for a current node of the current level, after the attribute prediction value corresponding to the child node of the current node is determined, the RAHT attribute transformation can be performed using the attribute prediction value of the corresponding child node, to obtain the corresponding DC coefficient and the AC coefficient, that is, the corresponding DC coefficient and the AC coefficient for the current node can be obtained. The DC coefficient is the low-frequency coefficient, and the AC coefficient is the high-frequency coefficient.

It should be noted that, in the embodiments of the present application, for the current node of the current level, the AC coefficient obtained by performing RAHT attribute transformation using the attribute prediction value corresponding to the child node can be understood as the prediction value of the high-frequency coefficient corresponding to the current node.

Further, in the embodiments of the present application, when the reconstructed values of the high-frequency coefficients corresponding to the nodes of the current level are determined according to the predicted value of the high-frequency coefficients, the bitstream may be decoded first, to determine the quantized coefficient residuals corresponding to the nodes of the current level. Then, the reconstructed values of the high-frequency coefficients corresponding to the nodes of the current level are determined according to the prediction values of the high-frequency coefficients and the quantized coefficient residuals.

Further, in the embodiments of the present application, when the reconstructed values of the high-frequency coefficients corresponding to the nodes of the current level are determined based on the prediction values of the high-frequency coefficients and the quantized coefficient residuals, the quantized coefficient residuals may be inversely quantized to determine the inversely quantized residuals corresponding to the nodes of the current level. Further, the reconstructed values of the high-frequency coefficients corresponding to the nodes of the current level may be determined according to the coefficient residuals corresponding to the nodes of the current level and the prediction values of the high-frequency coefficients corresponding to the nodes of the current level.

For example, in some embodiments, the coefficient residuals corresponding to the nodes of the current level and the prediction values of the high-frequency coefficients corresponding to the nodes of the current level may be summed to obtain the reconstructed values of the high-frequency coefficients corresponding to the nodes of the current level.

Further, in the embodiments of the present application, after the low-frequency coefficients and the reconstructed values of the high-frequency coefficients of the nodes of the current level are determined, the RAHT inverse transform may be performed based on the reconstructed values of the high-frequency coefficients and the low-frequency coefficients, to determine the reconstructed attribute values of the child nodes.

Exemplarily, in some embodiments, it is assumed that

$${g}_{L , 2 x , y , z}^{′} and {g}_{L , 2 x + 1 , y , z}^{′}$$

are two attribute DC coefficients for two nodes that are nearest neighbors relative to each other in the L level. After the linear transformation, the information of the L-1 level is AC coefficient

$${f}_{L - 1 , x , y , z}^{′}$$

and DC coefficient

$${g}_{L - 1 , x , y , z}^{′} .$$

Then, transformation will not performed on

$${f}_{L - 1 , x , y , z}^{′}$$

and quantization and encoding may be performed directly on

$${f}_{L - 1 , x , y , z}^{′} ,$$

transformation is performed continuously on

$${g}_{L - 1 , x , y , z}^{′}$$

by finding the nearest neighbor. If no nearest neighbor is found, it will be directly transferred to the L-2 level. That is, the RAHT is only valid for nodes with neighbor points, and nodes without neighbor points will be directly transferred to the upper level. In the transformation process, the weights corresponding to

$${g}_{L , 2 x , y , z}^{′} and {g}_{L , 2 x + 2 , y , z}^{′}$$

(the number of non-empty child nodes in the node) are

$${w}_{L , 2 x , y , z}^{′} and {w}_{L , 2 x + 1 , y , z}^{′}$$

(abbreviated as

$${w}_{0}^{′} and {w}_{1}^{′}$$

respectively, and the weight for

$${g}_{L - 1 , x , y , z}^{′} is {w}_{L - 1 , x , y , z}^{′} ,$$

then the general transformation formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

Where T_{w0,w1} is the transformation matrix, and the transformation matrix may be updated adaptively with the weights corresponding to each point. The forward transformation of the RAHT (which may also be referred to as the “forward RAHT”) is shown in FIG. 35A described above.

For example, in some embodiments, the inverse transformation of the RAHT is performed according to the obtained DC coefficients and AC coefficients of the child nodes of the current node, to recover the reconstructed attribute values of the child nodes of the current node. The inverse transform of the RAHT (which may also be referred to as “inverse RAHT”) is as shown in FIG. 35B.

That is, in the embodiments of the present application, if the first node number and the second node number corresponding to the nodes of the current level are different, processes such as transformation and prediction may be sequentially and continuously performed on the nodes of the current level. Specifically, for the current node of the current level, the predicted attribute of each child node of the current node can be obtained by performing linear fitting using the reconstructed attributes of the neighboring nodes of the current node and the spatial geometric distance between each neighboring node and each child node of the current node. Then, the prediction attribute of each child node is used to carry out RAHT attribute transformation to obtain corresponding DC and AC coefficients, then the predicted AC coefficient of the node (the predicted value of the high-frequency coefficient) and the AC coefficient (coefficient difference) obtained from the bitstream to recover the AC coefficient (the reconstructed value of the high-frequency coefficient) of the current node to be decoded (the current node).

Further, in the embodiments of the present application, if the current level is a non-skip coding level, after sequentially performing processes such as transformation and prediction on the nodes of the current level to determine the reconstructed attribute values of the child nodes corresponding to the nodes of the current level, based on the preset prediction mode, for the child nodes of the nodes of the current level, the third node number of child nodes in the next level corresponding to the child nodes may be determined first. Then, the reconstructed attribute values of the child nodes in the next level corresponding to the child node are determined according to the second node number and the third node number.

That is, in the embodiments of the present application, regardless of whether the current level is a skip coding level, that is, regardless of whether the processes such as transformation and prediction are sequentially performed on the nodes of the current level, based on the preset prediction mode, it is still necessary to determine the number of nodes of other levels and the number of child nodes of the nodes, and then whether or not to perform the skip processing of RAHT is determined based on the number of nodes and the number of child nodes of the nodes.

Accordingly, in the embodiments of the present application, the method of operations 101 to 102 is continuously repeated, and is sequentially repeated from the root node for the RAHT to the last node of the leaf node level for the RAHT, thereby completing the decoding of the entire RAHT attribute.

In summary, in the embodiments of the present application, when encoding and decoding attribute information, if the number of nodes in the current level is consistent with the number of child nodes of nodes in the current level, it is considered that the current level belongs to the skip coding level, and thus there is no need to perform processes such as transformation, prediction, encoding, and decoding on the current level, so that the time complexity of encoding and decoding for the attribute transformation can be reduced, and the encoding efficiency of the attribute will not be affected.

Exemplarily, in some embodiments, modifications to the SPEC are as follows:

### 10.5.2.2 State Variables

The RAHT tree is specified in terms of the following state variables:

The sparse array RahtCoeff of transform block coefficients; RahtCoeff [lvl][bs][bt][bv][i] is the i-th coefficient for the block located at (bs, bt, bv) in transform level lvl. Unset elements shall be inferred to be 0.

The array RahtBlkLoc of transform block locations; RahtBlkLoc [lvl][nIdx][k] is the location of the nIdx-th coded block in transform level lvl.

The array RahtBlkCnt of node counts per tree level; RahtBlkCnt [lvl] is the number of blocks in transform level lvl.

The variable RahtLvlCnt, the number of transform levels.

### 10.5.2.3Transform Block Weight

The weight of the DC transform coefficient for a block located at (bs, bt, bv) in transform level lvl is specified by the expression RahtBlkWeight [lvl][bs][bt][bv]. It is equal to the number of points that the coefficient applies to.

The sum of all block weights in any transform level is equal to the number of coded points (PointCnt).

A block's weight is equal to the sum of its child block weights.

```
RahtBlkWeight[lvl][bs][bt][bv] :=
    RahtBlkWeight = 0
    for (ptIdx = 0; ptIdx < PointCnt; ptIdx++)
      RahtBlkWeight += isPointInSubtree[ptIdx]
  where
    isPointInSubtree[ptIdx] :=
        bs == AttrPos[ptIdx][0] >> lvl
      && bt == AttrPos[ptIdx][1] >> lvl
      && bv == AttrPos[ptIdx][2] >> lvl
```

### 10.5.2.4 Number of Transform Levels and Per-Level Block Order

The root node of the transform tree is the lowest block in the tree with a DC coefficient that spans the entire geometry; i.e. it has a weight equal to the number of coded points, PointCnt.

The tree level containing the root node is RahtRootLvl:

$$RahtRootLvl := RahtLvlCnt - 1$$

Within a transform level, blocks are ordered for coefficient coding by ascending Morton-coded block location, as specified by the derivation of RahtBlkLoc. Empty blocks are ignored.

```
for (RahtLvlCnt = 0; !done; RahtLvlCnt++)
  for (mIdx = 0, nIdx = 0, wSum = 0; wSum < PointCnt; mIdx++) {
    (bs, bt, bv) = FromMorton(mIdx)
    wSum += RahtBlkWeight[RahtLvlCnt][bs][bt][bv]
    if (RahtBlkWeight[RahtLvlCnt][bs][bt][bv] == 0)
      continue
    RahtBlkCnt[RahtLvlCnt]++
    RahtBlkLoc[RahtLvlCnt][nIdx][0] = bs
    RahtBlkLoc[RahtLvlCnt][nIdx][1] = bt
    RahtBlkLoc[RahtLvlCnt][nIdx][2] = bv
    nIdx++
    done = RahtBlkWeight[RahtLvlCnt][bs][bt][bv] == PointCnt
  }
```

### 10.5.2.5 2×2×2 Transform Block Coefficient Weights

Transform coefficient weights are specified for each directional stage of the two-point transform for 2×2×2 blocks the transform by expression

RahtCoeffWeightM [1vl][stage][bs][bt][bv][m]; the parameter(s):

bs, bt and bv specify a transform block location in tree level lvl, lvl>0;

m specifies the transform coefficient index in forward transform stage stage.

$$RahtCoeffWeightM [ lvl ] [ stage ] [ bs ] [ bt ] [ bv ] [ m ] := RahtCoeffWeight [ lvl ] [ stage ] [ s ] [ t ] [ v ]$$

where

$$s := 2 \times bs + FromMorton [ m ] [ 0 ]$$

$$t := 2 \times bt + FromMoiton [ m ] [ 1 ]$$

$$v := 2 \times bv + FromMorton [ m ] [ 2 ]$$

Within a block, coefficient weights are determined iteratively starting from its child block weights (stage 0) to the transform block coefficient weights of stage 3. At each transform stage and for each pair of inverse-transformed values a and b, the weight for the DC (wL) and AC (wH) coefficient is the sum of the weights for a and b. If the weight for either a or b is 0, the AC coefficient weight is 0.

The expression RahtCoeffWeight[lvl][stage][s][t][v] specifies the derivation of a weight in transform stage stage for the coefficient corresponding to the block located at (s, t, v) in tree level lvl−1.

$$RahtCoeffWeight [ lvl ] [ stage ] [ s ] [ t ] [ v ] :=$$

$$stage == 0 ? RahtBlkWeight [ lvl - 1 ] [ s ] [ t ] [ v ] :$$

$$stage == 1 ? v \% 2 == 0 ? wL [ 0 ] [ 0 ] [ 1 ] : wH [ 0 ] [ 0 ] [ - 1 ] :$$

$$stage == 2 ? t \% 2 == 0 ? wL [ 0 ] [ 1 ] [ 0 ] : wH [ 0 ] [ - 1 ] [ 0 ] :$$

$$stage == 3 ? s \% 2 == 0 ? wL [ 1 ] [ 0 ] [ 0 ] : wH [ - 1 ] [ 0 ] [ 0 ] : na$$

$$where$$

$$wL [ ds ] [ dt ] [ dv ] := wSum [ ds ] [ dt ] [ dv ]$$

$$wH [ ds ] [ dt ] [ dv ] := wSum [ ds ] [ dt ] [ dv ] \times wHnz [ ds ] [ dt ] [ dv ]$$

$$wSum [ ds ] [ dt ] [ dv ] := wP [ s ] [ t ] [ v ] + wP [ s + ds ] [ t + dt ] [ v + dv ]$$

$$wHnz [ ds ] [ dt ] [ dv ] := wP [ s ] [ t ] [ v ] \times wP [ s + ds ] [ t + dt ] [ v + dv ] > 0$$

$$wP [ s ] [ t ] [ v ] := RahtCoeffWeight [ lvl ] [ stage - 1 ] [ s ] [ t ] [ v ]$$

$$RahtBlkWeight [ lvl ] [ s ] [ t ] [ v ] ≡ RahtCoeffWeight [ lvl ] [ 3 ] [ 2 \times s ] [ 2 \times t ] [ 2 \times v ] ; lvl > 0.$$

In the example of FIG. 18, block B has stage 0 coefficient weights of 1, 3 and 1; stage 1 and 2 weights of 1, 4 and 1; and stage 3 weights of 5, 4 and 5. RahtCoeffWeight[1][1][3][0][2] would be 4.

### 10.5.3 Coefficient Order

### 10.5.3.1 General

Subclause 10.5.3 specifies the correspondence between coded transform coefficients and the transform tree.

Starting from the root of the transform tree and proceeding in breadth-first order, coefficients are coded for each transform block; all transform blocks within one tree level are coded before those of the next level. Within a tree level, blocks shall be traversed in ascending Morton order of block location.

The order of coefficients within a transform block is specified by 10.5.3.2 for 2×2×2 blocks (tree levels greater than 0) and 10.5.3.3 for blocks of co-located points (tree level 0).

The mapping from the coded order to the transform tree is specified in terms of the following variables:

Lvl, the index of the mapped transform level.

CoeffIdx, the index into the decoded coefficient array AttrCoeff for the next mapped coefficient.

```
CoeffIdx = 0
for (Lvl = RahtLvlCnt; Lvl ≥ 0; Lvl−−) {
  if (Lvl > 0) {
    ... /* See 10.5.3.2 */
if(RahtBlkCnt[Lvl]== RahtBlkCnt[Lvl])
      continue
  } else {
    ... /* See 10.5.3.3 */
  }
}
```

That is, in the encoding and decoding method according to the embodiments of the present application, when performing RAHT encoding on an attribute, each RAHT encoding level determines whether the current RAHT encoding level belongs to a skip encoding level by determining whether the number of nodes of a current level coincides with the number of child nodes of the nodes of current level. That is, it is determined whether to skip processes such as transformation and prediction for the current level. If the number of the nodes of the current level is consistent with the number of the child nodes of the nodes of the current level, it is considered that the current level belongs to the skip coding level, and the processes such as transformation, prediction, encoding and decoding are not required for the current level. Therefore, the time complexity of attribute transformation coding and decoding may be reduced, and the encoding efficiency of attributes will not be affected.

The embodiments of the present application provide a decoding method. A decoder determines a first node number of nodes of a current level and a second node number of a child nodes corresponding to the nodes of the current level, the first node number and the second node number are used to determine whether to perform RAHT on the nodes of the current level; and determines reconstructed attribute values of the child nodes corresponding to the nodes of the current level according to the first node number and the second node number. Thus, in the embodiments of the present application, when predicting the attribute information, the first node number of the nodes of the current level and the second node number of the corresponding child nodes can be obtained first, so that in the process of reconstructing the attribute information of the child nodes corresponding to the nodes of the current level based on the first node number and the second node number, it is possible to determine whether or not the RAHT of the current level is skipped according to the first node number and the second node number, thereby effectively removing the redundancy of attributes, improving the attribute encoding and decoding efficiency of the point cloud, and further improving the coding and decoding performance of the point cloud.

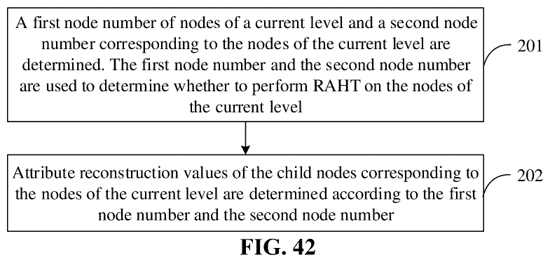

An embodiment of the present application provides an encoding method. FIG. 42 shows a schematic flowchart of the encoding method according to the embodiment of the present application. As shown in FIG. 42, when performing encoding processing on a point cloud, the encoding methods may include the following operations.

At Operation 201, a first node number of nodes of a current level and a second node number corresponding to the nodes of the current level are determined. The first node number and the second node number are used to determine whether to perform RAHT on the nodes of the current level.

In the embodiments of the present application, the first node number of the nodes of the current level may be determined first, and the second node number corresponding to the nodes of the current level may be determined at the same time.

It should be noted that the encoding method according to the embodiments of the present application specifically refers to a point cloud encoding method, and the method can be applied to a point cloud encoder (also referred to as an “encoder” for short).

Accordingly, in the embodiments of the present application, the current level may be a RAHT level to be encoded.

Further, in the embodiments of the present application, it is necessary to construct the RAHT attribute transformation encoding structure based on the geometric information of the points in the point cloud first. Specifically, the transformation can be continuously performed starting from the voxel level until the root node is obtained, thereby completing the hierarchical transformation encoding of the entire attribute, and then the RAHT attribute transformation encoding structure including at least one RAHT level may be obtained.

It should be noted that, in the embodiments of the present application, the RAHT attribute transformation may be performed based on the order of the octree hierarchy. In the process of constructing the RAHT attribute transformation coding structure, based on the hierarchical order of the octree, the transformation may be performed continuously starting from the voxel level until the root node is obtained. In the process of attribute prediction transform coding, it can also be based on the hierarchical order of octree, but it is continuously transformed from the root node to the voxel level.

It can be understood that in the embodiments of the present application, a level obtained by sequentially downsampling along a preset direction, such as the Z direction, the Y direction, and the X direction, may be defined as a RAHT level, such as a current level (layer).

It should be noted that, in the embodiments of the present application, for the current level, the current level may include at least one point. When the current level is encoded, the at least one point in the current level may be used as a node to be encoded in the current level.

Further, in the embodiments of the present application, each point in the current level corresponds to one piece of geometric information and one piece of attribute information. The geometric information represents the spatial relationship of the point, and the attribute information represents the related information of the attributes of the point.

Here, the attribute information may be color information, reflectivity, or other attributes, which is not particularly limited in the embodiments of the present application. Here, when the attribute information is color information, specifically, the attribute information may be color information in any color space. For example, the attribute information may be color information in the RGB space, color information in the YUV space, color information in the YCbCr space, or the like, a which is not specifically limited in the embodiments of the present application.

It should be noted that, in the embodiments of the present application, when performing RAHT transformation encoding, first, attribute transformation and the inverse transformation for the nodes at the non-voxel level are completed, and second, the transformation for the nodes at the voxel level is completed, because there may be a phenomenon of repeated points in the point cloud.

Accordingly, in the embodiments of the present application, if the nodes of the current level are at a non-voxel level, the first node number may represent the number of occupied nodes of the current level. The second node number may then represent the number of occupied child nodes in the nodes of the current level.

Accordingly, in the embodiments of the present application, if the nodes of the current level are at the voxel level, the first node number may represent the number of occupied nodes of the current level. The second node number may then represent the number of nodes to be encoded.

That is, in the embodiments of the present application, the first node number is the number of valid nodes (i.e. occupied nodes) of the current level. For nodes at the non-voxel level, the second node number is the number of valid child nodes of the current level (i.e. occupied child node). For nodes at the voxel level, the second node number is the number of nodes to be encoded.

Further, in the embodiments of the present application, the geometric information of the nodes of the current level may be determined first. Then, the child nodes corresponding to the nodes of the current level and the second node number are determined according to the geometric information.

It should be noted that, in the embodiments of the present application, for a current node of the current level, when the corresponding child node is determined by using the geometric information of the current node, the geometric information of the current node can be used to perform up-sampling to obtain the occupied child node in the current node (the number of child nodes is N, and the maximum value of Nis 8).

For example, in some embodiments, when encoding is performed on the attribute information of the nodes of the current level, the number of nodes of the current level, that is, the first node number, may be obtained first. After the child nodes of the nodes of the current level is recovered by using the geometric information of the nodes of the current level, the number of child nodes of the nodes of the current level, that is, the second node number, may be obtained.

Further, in the embodiments of the present application, identification information of a prediction mode may be determined first. If the value of the identification information of the prediction mode is a first value, it is determined that the prediction mode corresponding to the nodes of the current level is a preset prediction mode. If the value of the identification information of the prediction mode is a second value, it is determined that the prediction mode corresponding to the nodes of the current level is not the preset intra prediction mode.

It is to be understood that, in the embodiments of the present application, the identification information of the prediction mode may be used to indicate whether or not the attribute information of the node of the current level is predicted in a preset prediction mode.

It should be noted that, in the embodiments of the present application, the preset prediction mode may be a prediction mode in which a coding level (RAHT level) is skipped selectively. Here, based on the preset prediction mode, it is possible to select whether or not to skip the current level according to the determined first node number and the second node number corresponding to the current level.

It should be noted that in the embodiments of the present application, the first value and the second value are different, and the first value and the second value may be in a parameter form or a numeric value form.

Exemplarily, in some embodiments, taking the first value set to 1 and the second value set to 0 as an example, the value of the identification information of the prediction mode is determined. If the value of the identification information of the prediction mode is 1, it is determined that the prediction mode corresponding to the nodes of the current level is the preset prediction mode, and the first node number and the second node number corresponding to the nodes of the current level may be further determined according to the above-described method. If the value of the identification information of the prediction mode is 0, it can be determined that the prediction mode corresponding to the nodes of the current level is not the preset prediction mode, and the prediction processing may be performed on the attribute information of the current level according to a common intra prediction method or an inter prediction method.

That is, in the embodiments of the present application, if the value of the determined identification information of the prediction mode is the first value, that is, it is determined that the prediction mode corresponding to the current level is the preset prediction mode, the process of determining the first node number and the second node number, that is, the process of operation 201, may be executed.

It should be noted that, in the embodiments of the present application, the first node number and the second node number may be used to determine whether or not to perform RAHT on the nodes of the current level. That is, after the first node number and the second node number are determined, it may be determined whether or not the subsequent processing flow of performing RAHT on the nodes of the current level is skipped according to the first node number and the second node number.

At Operation 202, reconstructed attribute values of the child nodes corresponding to the nodes of the current level are determined according to the first node number and the second node number.

In the embodiments of the present application, after determining the first node number and the second node number corresponding to the nodes of the current level, the reconstructed attribute values of the child nodes corresponding to the nodes of the current level may be further determined according to the first node number and the second node number.

Further, in the embodiments of the present application, after determining the first node number and the second node number corresponding to the nodes of the determined current level, whether the encoding or decoding for the attribute information of the coding level (current level) is skipped may be determined by using the first node number and the second node number corresponding to the nodes of the current level.

It can be understood that, in the embodiments of the present application, since the RAHT is only valid for nodes having neighbor points, if the number of nodes in the current level is completely consistent with the number of child nodes of the nodes in the current level, it may indicate that each node in the current level has only one child node. In this case, AC coefficients (high-frequency coefficients) may not be generated for the current level, so it is possible to skip the processes such as transformation and prediction sequentially performed on the nodes in the current level.

That is, in the embodiments of the present application, by using the number of nodes of the current level and the number of child nodes of the current level, it is possible to adaptively determine whether encoding and decoding for the current level may be skipped. The key to determining whether to skip the encoding and decoding processing for the current level is whether the number of nodes in the current level is the same as the number of child nodes, that is, whether the first node number and the second node number are the same.

Further, in the embodiments of the present application, when the reconstructed attribute values of the child node corresponding to the node of the current level is determined according to the first node number and the second node number, if the first node number and the second node number are the same, the reconstructed attribute values of the nodes of the current level are determined as the reconstructed attribute values of the child nodes corresponding to the nodes of the current level.

It can be understood that, in the embodiments of the present application, if the first node number and the second node number corresponding to the nodes of the current level are the same, that is, it can be determined that the number of nodes of the current level is the same as the number of child nodes corresponding to the nodes of the current level, then it may be considered that only one child node corresponds to each node of the current level.

Accordingly, in the embodiments of the present application, since the RAHT is valid only for nodes having neighbor points, in the process of RAHT attribute transformation, if each node of the current level corresponds to only one child node, it can be considered that AC coefficients may not be generated for the current level. Therefore, the processes such as transformation and prediction may not be sequentially performed on the nodes of the current level, that is, the processes for the current level are skipped, and at this time, the current level can be used as a skip decoding level.

Accordingly, in the embodiments of the present application, if it is determined that the first node number and the second node number corresponding to the nodes of the current level are the same, that is, it is determined that the current level is a skip decoding level, then it is possible to skip the processes such as transformation and prediction sequentially performed on the nodes of the current level. Instead, the reconstructed attribute values of the nodes of the current level may be directly determined as the reconstructed attribute values of the child nodes corresponding to the nodes of the current level.

That is, in the embodiments of the present application, in the process of RAHT attribute transformation, if each node of the current level has only one child node, it is possible to select not to sequentially perform the processes such as transformation and prediction on the nodes of the current level, thereby reducing the complexity of RAHT attribute transformation encoding and decoding.

Further, in the present embodiments of the present application, when the reconstructed attribute values of the child nodes corresponding to the nodes of the current level are determined according to the first node number and the second node number, if the first node number and the second node number are the same, and the current level is determined to be a skip decoding level, it may skip the current level to the next level, and the prediction processing of the attribute information may be directly performed on the next level according to the preset prediction mode.

Accordingly, in the embodiments of the present application, based on the preset prediction mode, for the child nodes of the nodes of the current level, a third node number of child nodes in a next level corresponding to the child nodes may be determined first. Then, the reconstructed attribute values of the child nodes in the next level corresponding to the child nodes are determined according to the second node number and the third node number.

It can be understood that, in the embodiments of the present application, if the child nodes of the nodes of the current level are nodes at a non-voxel level, the third node number may be the number of effective child nodes in the next level (that is, the child node occupied in the next level) of the child nodes of the nodes in the current level. If the child nodes of the nodes of the current level are nodes at a voxel level, the second node number may be the number of nodes to be encoded.

It should be noted that, in the embodiments of the present application, based on the preset prediction mode, after the second node number and the third node number are determined, the second node number and the third node number may be used to determine whether or not to skip encoding and decoding for attribute information of the encoding level (the next level of the current level).

For example, in some embodiments, if the second node number and the third node number are the same, sequentially performing the processes such as transformation and prediction may not be performed on the child nodes of the nodes of the current level, that is, the processing for the child nodes of the current level may be skipped, and the reconstructed attribute values of the child nodes corresponding to the nodes of the current level may be determined directly as the reconstructed attribute values of the child nodes in the next level of the child nodes corresponding to the nodes of the current level.

Further, in the embodiments of the present application, when the reconstructed attribute values of the child nodes corresponding to the nodes of the current level are determined according to the first node number and the second node number, if the first node number and the second node number corresponding to the nodes of the current level are different, that is, it may be determined that the number of nodes of the current level is different from the number of child nodes corresponding to the nodes of the current level. At this time, AC coefficients may be sill generated for the current level. Therefore, processes such as transformation and prediction may be continuously and sequentially performed for the nodes of the current level, the processes for the nodes of the current level may not be skipped. At this time, the current level may be regarded as a non-skip decoding level.

Accordingly, in the embodiments of the present application, if it is determined that the first node number and the second node number corresponding to the nodes of the current level are different, that is, it is determined that the current level is a non-skip decoding level, the attribute prediction values of the child nodes corresponding to the nodes of the current level may be determined according to the nodes of the current level. Then RAHT may be performed based on the attribute prediction values of the child nodes and the attribute values of the child nodes, to determine the reconstructed values of the high-frequency coefficients and the low-frequency coefficients corresponding to the nodes of the current level. Next, inverse RAHT is performed based on the low-frequency coefficients and the reconstructed values of the high-frequency coefficients to determine the reconstructed attribute values of child nodes.

Further, in the embodiments of the present application, when the attribute prediction values of the child nodes corresponding to the nodes of the current level are determined according to the nodes of the current level, a neighboring node corresponding to the nodes of the current level may be determined first. Then, the attribute prediction values of the child nodes corresponding to the nodes of the current level are determined according to the reconstructed attribute value corresponding to the neighboring node and the relative distance parameter.

It should be noted that, in the embodiments of the present application, the relative distance parameter corresponding to the neighboring node may represent the spatial geometric distance between the child nodes corresponding to the nodes of the current level and the corresponding neighboring node.

Exemplarily, in some embodiments, for a current node of a current level, the current node includes two child nodes, a child node 1 and a child node 2, the relative distance parameter between the current node and the neighboring node may include a spatial geometric distance between the child node 1 and the neighboring node, and may also include a spatial geometric distance between the child node 2 and the neighboring node.

For example, in some embodiments, when the attribute prediction values of the child nodes corresponding to the nodes of the current level are determined according to the nodes of the current level, for the current node of the current level, the reconstructed attribute (reconstructed attribute values) of the neighborhood node (neighboring node) of the current node and the spatial geometric distance between each neighborhood node and the child node of the current node may be used to perform linear fitting, to obtain the predicted attribute value of each child node of the current node finally.

Exemplarily, in some embodiments, for the current node of the current level, 19 neighboring nodes of the current node may be determined first. Then, the attribute of each child node may be predicted in a way of linear weighting using the spatial geometric distances between the neighboring nodes and the child node of the current node, to finally obtain the attribute prediction value of the child node.

Further, in the embodiments of the present application, when the RAHT is performed based on the attribute prediction values of the child nodes and the attribute vales of the child nodes to determine the low-frequency coefficients and the reconstructed values of the high-frequency coefficients corresponding to the nodes of the current level, the RAHT may be performed based on the attribute prediction values of the child nodes, to determine the low-frequency coefficients and the prediction values of the high-frequency coefficients corresponding to the nodes of the current level. At the same time, the RAHT may be performed based on the attribute vales of the child nodes, to determine the high-frequency coefficients and the low-frequency coefficients. Then, the reconstructed values of the high-frequency coefficients corresponding to the nodes of the current level are determined according to the prediction values of the high-frequency coefficients corresponding to the nodes of the current level and the high-frequency coefficients corresponding to the nodes of the current level.

It can be understood that, in the embodiments of the present application, for a current node of the current level, after the attribute prediction value corresponding to the child node of the current node is determined, the RAHT attribute transformation can be performed using the attribute prediction value of the corresponding child node, to obtain the corresponding DC coefficient and the AC coefficient, that is, the corresponding DC coefficient and the AC coefficient for the current node can be obtained. The DC coefficient is the low-frequency coefficient, and the AC coefficient is the high-frequency coefficient.

It should be noted that, in the embodiments of the present application, for the current node of the current level, the AC coefficient obtained by performing RAHT attribute transformation using the attribute prediction value corresponding to the child node can be understood as the prediction value of the high-frequency coefficient corresponding to the current node.

Accordingly, in the embodiments of the present application, for the current node of the current level, the DC coefficient and the AC coefficient corresponding to the current node can be obtained by performing RAHT attribute transformation using the attribute value of the child node. The DC coefficient is the low-frequency coefficient, and the AC coefficient is the high-frequency coefficient. The AC coefficient determined based on the attribute value of the child node of the current node can be understood as the original value of the high-frequency coefficient corresponding to the current node.

Further, in the embodiments of the present application, when the reconstructed values of the high-frequency coefficients corresponding to the nodes of the current level are determined based on the prediction values of the high-frequency coefficients corresponding to the nodes of the current level and the high-frequency coefficients corresponding to the nodes of the current level, coefficient residuals corresponding to the nodes of the current level may be determined first based on the prediction values of the high-frequency coefficients corresponding to the nodes of the current level and the high-frequency coefficients corresponding to the nodes of the current level. Then, the reconstructed values of the high-frequency coefficients corresponding to the nodes of the current level may be further determined according to the coefficient residuals corresponding to the nodes of the current level.

It should be noted that, in the embodiments of the present application, after the coefficient residuals corresponding to the nodes of the current level are obtained, the coefficient residuals may be further quantized to determine the quantized coefficient residuals corresponding to the nodes of the current level. Then, the quantized coefficient residuals may be written into the bitstream and transmitted to the decoding end, so that the decoder may reconstruct the corresponding high-frequency coefficients according to the quantized coefficient residuals obtained by decoding the bitstream.

Further, in the embodiments of the present application, after the coefficient residuals corresponding to the nodes of the current level are quantized to obtain the corresponding quantized coefficient residuals, the quantized coefficient residuals may be further inversely quantized to determine the inversely quantized residuals corresponding to the nodes of the current level. Then, the reconstructed values of the high-frequency coefficients corresponding to the nodes of the current level may be determined according to the inversely quantized residuals corresponding to the nodes of the current level and the prediction values of the high-frequency coefficients corresponding to the nodes of the current level.

For example, in some embodiments, the coefficient residuals corresponding to the nodes of the current level and the prediction values of the high-frequency coefficients corresponding to the nodes of the current level may be summed to obtain the reconstructed values of the high-frequency coefficients corresponding to the nodes of the current level.

Further, in the embodiments of the present application, after the low-frequency coefficients and the reconstructed values of the high-frequency coefficients of the nodes in the current level are determined, the RAHT inverse transform may be performed based on the reconstructed values of the high-frequency coefficient and the low-frequency coefficients, to determine the reconstructed attribute values of the child nodes.

Exemplarily, in some embodiments, it is assumed that

$${g}_{L , 2 x , y , z}^{′} and {g}_{L , 2 x + 1 , y , z}^{′}$$

are two attribute DC coefficients for two nodes that are nearest neighbors relative to each other in the L level. After the linear transformation, the information of the L-1 level is AC coefficient

$${f}_{L - 1 , x , y , z}^{′}$$

and DC coefficient

$${g}_{L - 1 , x , y , z}^{′} .$$

Then, transformation will not performed on

$${f}_{L - 1 , x , y , z}^{′}$$

and quantization and encoding may be performed directly on

$${f}_{L - 1 , x , y , z}^{′} ,$$

transformation is performed continuously on

$${g}_{L - 1 , x , y , z}^{′}$$

by finding the nearest neighbor. If no nearest neighbor is found, it will be directly transferred to the L-2 level. That is, the RAHT is only valid for nodes with neighbor points, and nodes without neighbor points may be directly transferred to the upper level. In the transformation process, the weights corresponding to

$${g}_{L , 2 x , y , z}^{′} and {g}_{L , 2 x + 2 , y , z}^{′}$$

(the number of non-empty child nodes in the node) are

$${w}_{L , 2 x , y , z}^{′} and {w}_{L , 2 x + 1 , y , z}^{′}$$

$$( abbreviated as {w}_{0}^{′} and {w}_{1}^{′} )$$

respectively, and the weight for

$${g}_{L - 1 , x , y , z}^{′} is {w}_{L - 1 , x , y , z}^{′} ,$$

then the general transformation formula is:

$$[ \begin{matrix}{g}_{L - 1 , x , y , z}^{′} \\ {f}_{L - 1 , x , y , z}^{′}\end{matrix} ] = {T}_{w 0 , w 1} [ \begin{matrix}{g}_{L , 2 x , y , z}^{′} \\ {g}_{L , 2 x + 1 , y , z}^{′}\end{matrix} ]$$

where T_{w0,w1} is the transformation matrix, and the transformation matrix may be updated adaptively with the weights corresponding to each point. The forward transformation of the RAHT (which may also be referred to as the “forward RAHT”) is shown in FIG. 35A described above.

For example, in some embodiments, the inverse transformation of the RAHT is performed according to the obtained DC coefficients and AC coefficients of the child nodes of the current node, to recover the reconstructed attribute values of the child nodes of the current node. The inverse transformation of the RAHT (which may also be referred to as “inverse RAHT”) is as shown in FIG. 35B.

That is, in the embodiments of the present application, if the first node number and the second node number corresponding to the nodes of the current level are different, processes such as transformation and prediction may be sequentially and continuously performed on the nodes of the current level. Specifically, for the current node of the current level, the predicted attribute of each child node of the current node can be obtained by performing linear fitting using the reconstructed attribute of the neighboring node of the current node and the spatial geometric distance between each neighboring node to each child node of the current node. Then, the RAHT attribute transformation is performed by using the predicted attribute of each child node to obtain corresponding DC and AC coefficients, and at the same time, the attribute of each child node of the current node can be transformed by using the RAHT attribute transformation to obtain DC and AC coefficients. Then, the prediction value of the AC coefficient obtained by a prediction node can be used to predict the AC coefficient of the current node, and then the AC prediction residual coefficient (coefficient residual) for each child node can be obtained, and then the coefficient residual can be quantized and encoded. On the other hand, the inversely quantized residual value of the AC prediction residual coefficient and the prediction value of the AC coefficient can also be used to recover the AC reconstruction coefficient of the current node (the reconstructed value of the high-frequency coefficient), and finally the AC coefficient and the DC coefficient of the current node can be used to perform inverse RAHT, so as to recover the reconstructed attribute value of each child node of the current node.

Further, in the embodiment of the present application, if the current level is a non-skip coding level, after sequentially performing processes such as transformation and prediction on the nodes of the current level to determine the reconstructed attribute values of the child nodes corresponding to the nodes of the current level, based on the preset prediction mode, the third node number of the child nodes in the next level corresponding to the child nodes may be determined first for the child nodes of the nodes of the current level. Then, the reconstructed attribute values of the child nodes in the next level corresponding to the child nodes are determined according to the second node number and the third node number.

That is, in the embodiments of the present application, regardless of whether the current level is a skip coding level, that is, regardless of whether the processes such as transformation and prediction are sequentially performed on the nodes of the current level, based on the preset prediction mode, it is still necessary to determine the number of nodes of other levels and the number of child nodes of the nodes, and then whether or not to perform the skip processing of RAHT is determined based on the number of nodes and the number of child nodes of the nodes.

Accordingly, in the embodiments of the present application, the method of operations 201 to 202 is continuously repeated, and is sequentially repeated from the root node for the RAHT to the last node of the leaf node level for the RAHT, thereby completing the encoding of the entire RAHT attribute.

In summary, in the embodiments of the present application, when encoding attribute information, if the number of nodes in the current level is consistent with the number of child nodes of nodes in the current level, it is considered that the current level belongs to the skip coding level, and thus there is no need to perform processes such as transformation, prediction, encoding, and decoding on the current level, so that the time complexity of encoding and decoding for the attribute transformation can be reduced, and the encoding efficiency of the attribute will not be affected.

That is, in the encoding and decoding methods according to the embodiments of the present application, when performing RAHT encoding on an attribute, in each RAHT encoding level, whether the current RAHT encoding level belongs to a skip coding level, that is, whether to skip processes such as transformation and prediction for the current level, is determined by determining whether the number of nodes in the current level coincides with the number of child nodes of the nodes in current level. If the number of nodes of the current level is consistent with the number of child nodes of the nodes of the current level, the current level is considered to belong to the skip coding level, and the processes such as transformation, prediction, encoding and decoding are not needed, so that the time complexity of encoding and decoding for the attribute transformation can be reduced, and the encoding efficiency of the attribute will not be affected.

An embodiment of the present application provides an encoding method. an encoder determines a first node number of nodes of a current level and a second node number of a child node corresponding to the nodes of the current level, the first node number and the second node number are used to determine whether to perform RAHT on the nodes of the current level; and determines reconstructed attribute values of the child nodes corresponding to the node of the current level according to the first node number and the second node number. Thus, in the embodiments of the present application, when predicting the attribute information, the first node number of the nodes of the current level and the second node number of the corresponding child nodes can be obtained first, so that in the process of reconstructing the attribute information of the child nodes corresponding to the nodes of the current level based on the first node number and the second node number, it is possible to determine whether or not the RAHT of the current level is skipped according to the first node number and the second node number, thereby effectively removing the redundancy of attributes, improving the efficiency of the attribute encoding and decoding for the point cloud, and further improving the performance of the encoding and decoding for the point cloud.

Based on the above embodiment, another embodiment of the present application proposes an encoding and decoding method, in which, when encoding attribute information, if the number of nodes of a current level is consistent with the number of child nodes of nodes of the current level, the current level is considered to belong to a skip coding level, and processes such as transformation, prediction, encoding, and decoding are not required, thereby reducing the time complexity of attribute transformation encoding/decoding, and not having any influence on attribute encoding efficiency.

It may be understood that in the RAHT attribute transform encoding of common G-PCC, encoding and decoding are performed in the order from the root node to the child nodes. Firstly, the geometric information of the nodes of the current level is used to recover the child node of the current level in the order of Z, Y and X. Secondly, the attributes of the nodes of the current level are predicted and decoded by using the reconstructed attributes of the parent node level, to recover the attributes of the nodes of the current level until it is transformed to the child node, that is, the voxel level. In common G-PCC, if the number of nodes in the current level is exactly the same as the number of child nodes in the current level, it indicates that each node in the current level has only one child node, that is, the current level will not produce AC coefficients. However, in common coding schemes, the processes such as transformation and prediction still need to be performed sequentially on the nodes in the current level, which will increase the complexity of coding and decoding of RAHT attribute transformation, and introduce a redundant operation.

For example, in some embodiments, the RAHT attribute encoding level may be defined first, and the current attribute RAHT encoding order is sequentially performing division from the root node to the voxel level (1×1×1), thereby completing the encoding and attribute reconstruction of the entire point cloud attribute. Here, the level obtained by down-sampling along the Z direction, Y direction and X direction each time is defined as a RAHT level, that is, layer.

Exemplarily, in some embodiments, an algorithm that skips the coding level is introduced based on the RAHT attribute coding level. First, when encoding/decoding the attributes of the nodes of the current level, the number of nodes of the current level may be obtained, and the number of child nodes of the nodes of the current level may be obtained after the geometric information of the nodes of the current level is used to recover the child nodes of the nodes of the current level, and whether the current level belongs to the skip coding level is determined based on the sizes of the number of nodes of the current level and the number of the child nodes.
If the number of the nodes of the current level is consistent with the number of child nodes of the current level node, the current level belongs to the skip coding level;
Otherwise, the current level is a non-skip coding level.

After obtaining the start condition of skipping the coding level, the specific algorithm of the encoding end is as follows:
Step 1: Determining whether the number of nodes of the current level is consistent with the number of child nodes of the nodes of the current level. If the number of nodes of the current level is consistent with the number of child nodes of the nodes of the current level, the current level belongs to a skip coding level. Otherwise, it is a non-skip coding level;
Step 2: If the current level does not belong to the skip coding level, performing transformation, prediction and coding according to the existing coding mode.
Step 3: If the current level belongs to the skip coding level, directly skip the current level to the next level.

The specific algorithm of the decoding end is as follows:
Step 1: Determining whether the number of nodes of the current level is consistent with the number of child nodes of the nodes of the current level. If the number of nodes of the current level is consistent with the number of child nodes of the nodes of the current level, the current level belongs to the skip decoding level. Otherwise, it is the non-skip decoding level;
Step 2: If the current level does not belong to the skip decoding level, performing prediction and decoding according to the existing decoding method.
Step 3: If the current level belongs to the skip decoding level, directly skip the current level to the next level.

In summary, in the encoding and decoding methods according to the embodiments of the present application, when performing RAHT encoding on an attribute, in each RAHT encoding level, it determines whether the current RAHT encoding level belongs to a skip encoding level by determining whether the number of the nodes of the current level is consistent with the number of the child nodes of the nodes of the current level, that is, determines whether to skip processes such as transformation and prediction for the current level. If the number of nodes of the current level is consistent with the number of child nodes of the nodes of the current level, it is considered that the current level belongs to the skip coding level, and the processes such as transformation, prediction, encoding and decoding are not required, so that the time complexity of attribute transformation coding and decoding can be reduced, and the encoding efficiency of attributes will not be affected.

The embodiments of the present application provide a coding method. A codec determines a first node number of nodes in a current level and a second node number of child nodes corresponding to the nodes of the current level The first node number and the second node number are used to determine whether to perform RAHT on the nodes of the current level; and determines reconstructed attribute values of the child nodes corresponding to the nodes of the current level according to the first node number and the second node number. Thus, in the embodiments of the present application, when predicting the attribute information, the first node number of the nodes of the current level and the second node number of the corresponding child nodes can be obtained first, so that in the process of reconstructing the attribute information of the child nodes corresponding to the nodes of the current level based on the first node number and the second node number, it is possible to determine whether or not the RAHT of the current level is skipped according to the first node number and the second node number, thereby effectively removing the redundancy of attributes, improving the attribute encoding and decoding efficiency of the point cloud, and further improving the encoding and decoding performance of the point cloud.

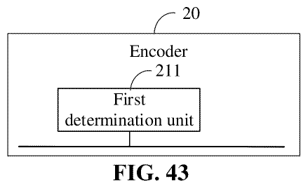

Based on the above-described embodiments, in yet another embodiment of the present application, and based on the same inventive concept as the above-described embodiments, FIG. 43 is a schematic diagram of a configuration structure of an encoder. As shown in FIG. 43, the encoder 20 may include: a first determining unit 211.

The first determination unit 211 is configured to determine a first node number of the nodes of the current level and a second node number of child nodes corresponding to the nodes of the current level, the first node number and the second node number are used to determine whether to perform RAHT on the nodes of the current level; and determine reconstructed attribute values of the child nodes corresponding to the nodes of the current level according to the first node number and the second node number.

It is to be understood that in the embodiments, a “unit” may be a part of a circuit, a part of a processor, a part of programs or software, etc., or it may also be a module, or it may be non-modular. Moreover, the various components in the embodiments may be integrated in one processing unit, or various units may exist physically alone, or two or more units may be integrated in one unit. The integrated unit can be implemented either in the form of hardware or in the form of software function module.

If the integrated unit is implemented in the form of software functional modules and sold or used as an independent product, it can be stored in a computer readable storage medium. Based on such understanding, the technical solution of the embodiment of the present disclosure can be embodied in the form of software products in essence or in the part that contributes to the prior art or in all or part of the technical solution. The computer software product is stored in a storage medium, includes several instructions used to enable a computer device (which can be a personal computer, a server, a network device, etc.) or a processor to perform all or part of the steps of the method according to the embodiments. The aforementioned storage media include: a U disk, a removable hard disk, a Read Only Memory (ROM), a Random Access Memory (RAM), a disk, an optical disk or other media that can store program codes.

Therefore, an embodiment of the present disclosure provides a computer-readable storage medium applied to the encoder 20, the computer-readable storage medium having stored therein a computer program that, when executed by a first processor, cause the first processor to implement the method of any of the aforementioned embodiments.

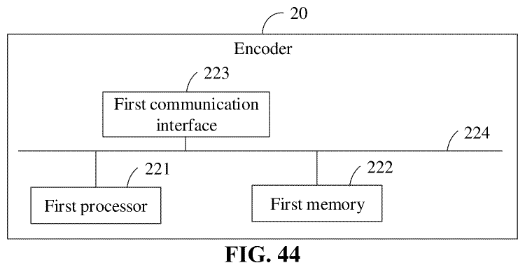

Based on the configuration of the encoder 20 and the computer-readable storage medium described above, FIG. 44 is a second schematic diagram of the configuration structure of the encoder. As shown in FIG. 44, the encoder 20 may include a first memory 222 and a first processor 221, a first communication interface 223, and a first bus system 224. The first memory 222, the first processor 221, and the first communication interface 223 are coupled together by a first bus system 224. It will be appreciated that the first bus system 224 is used to enable connection and communication between these components. The first bus system 224 includes a power bus, a control bus, and a status signal bus in addition to a data bus. However, for clarity of illustration, the various buses are designated as first bus system 224.

The first communication interface 223 is used for receiving/transmitting signals in the process of transmitting/receiving information with other external network elements.

The first memory 222 is used for storing a computer program executable on the first processor.

The first processor 221 is configured to determine a first node number of the nodes of the current level and a second node number of child nodes corresponding to the nodes of the current level, the first node number and the second node number are used to determine whether to perform RAHT on the nodes of the current level; and determine reconstructed attribute values of the child nodes corresponding to the nodes of the current level according to the first node number and the second node number.

It may be understood that the first memory 222 in the embodiments of the application may be a volatile memory or a non-volatile memory, or may include the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), which is used as an external high-speed cache. By way of example but not restrictive description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). The first memory 222 of the systems and methods described in this application includes these memories (but is not limited to these memories) and any other proper types of memories.

The first processor 221 may be an integrated circuit chip with signal processing capacity. In an implementation process, various steps of the above methods may be completed by integrated logic circuits of hardware in the first processor 221 or instructions in the form of software. The above first processor 221 may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, steps, and logical block diagrams disclosed in the embodiments of the application may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software modules may be located in a storage medium mature in the art, such as a random access memory, a flash memory, a read-only memory, a programmable read-only memory or an electrically erasable programmable memory, or a register. The storage medium is located in the first memory 222, and the first processor 221 reads information in the first memory 222 and completes the steps in the foregoing methods in combination with hardware of the processor.

It will be appreciated that the embodiments described herein may be implemented in hardware, software, firmware, middleware, microcode or a combination thereof. For the hardware implementation, the processing unit may be implemented in one or more Application Specific Integrated Circuits (ASIC), Digital Signal Processors (DSPD), Digital Signal Processing Devices (DSPD), Programmable Logic Devices (PLD), Field-Programmable Gate Arrays (FPGA), general purpose processors, controllers, microcontrollers, microprocessors, other electronic units or combinations thereof for performing the functions described herein. For software implementations, the technology described herein may be implemented by modules (e.g, procedures, functions, etc.) that perform the functions described herein. The software codes may be stored in memory and executed by a processor. The memory can be implemented in the processor or outside the processor.

Optionally, as another embodiment, the first processor 221 is further configured to execute the computer program to perform the method described in any one of the aforementioned embodiments.

An embodiment of the present application provides an encoder. The encoder determines a first node number of nodes of a current level and a second node number of child nodes corresponding to the nodes of the current level, the first node number and the second node number are used to determine whether to perform RAHT on the nodes of the current level; and determines reconstructed attribute values of the child nodes corresponding to the nodes of the current level according to the first node number and the second node number. Thus, in the embodiment of the present application, when predicting the attribute information, the first node number of the nodes of the current level and the second node number of the corresponding child nodes can be obtained first, so that in the process of reconstructing the attribute information of the child nodes corresponding to the nodes of the current level based on the first node number and the second node number, it is possible to determine whether or not the RAHT of the current level is skipped according to the first node number and the second node number, thereby effectively removing attribute redundancy, improving the efficiency of the attribute encoding and decoding for the point cloud, and further improving the encoding and decoding performance for the point cloud.

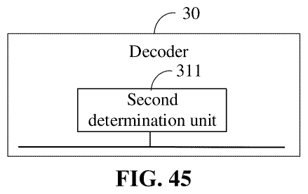

FIG. 45 is a schematic diagram of a configuration structure of a decoder. As shown in FIG. 45, the decoder 30 may include: a second determination unit 311.

The second determination unit 311 is configured to determines a first node number of nodes of a current level and a second node number of child nodes corresponding to the nodes of the current level, the first node number and the second node number are used to determine whether to perform RAHT on the nodes of the current level; and determines reconstructed attribute values of the child nodes corresponding to the nodes of the current level according to the first node number and the second node number.

It is to be understood that in the embodiment, a “unit” may be a part of a circuit, a part of a processor, a part of programs or software, etc., or it may also be a module, or it may be non-modular. Moreover, the various components in the embodiments of the present disclosure may be integrated in one processing unit, or various units may exist physically alone, or two or more units may be integrated in one unit. The integrated unit can be implemented either in the form of hardware or in the form of software function module.

If the integrated unit is implemented in the form of software functional modules and sold or used as an independent product, it can be stored in a computer readable storage medium. Based on such understanding, the technical solution of the present disclosure, the technical solution of the embodiment of the present disclosure can be embodied in the form of software products in essence or in the part that contributes to the prior art or in all or part of the solution. The computer software product is stored in a storage medium, includes several instructions used to enable a computer device (which can be a personal computer, a server, a network device, etc.) or a processor to perform all or part of the steps of the method according to each embodiment of the present disclosure. The aforementioned storage media include: a U disk, a removable hard disk, an ROM, an RAM, a disk, an optical disk or other media that can store program codes.

Therefore, an embodiment of the present disclosure provides a computer-readable storage medium applied to the decoder 30, the computer-readable storage medium having stored therein a computer program that, when executed by a first processor, cause the first processor to implement the method of any of the aforementioned embodiments.

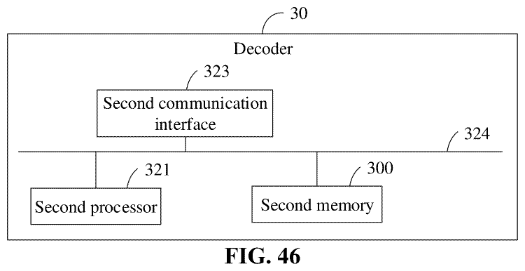

Based on the configuration of the decoder 30 and the computer-readable storage medium described above, FIG. 46 is a second schematic diagram of the configuration structure of the decoder. As shown in FIG. 46, the decoder 30 may include a second memory 322 and a second processor 321, a second communication interface 323, and a second bus system 324. The second memory 322 and the second processor 321, the second communication interface 323 are coupled together by a second bus system 324. It will be appreciated that the second bus system 324 is used to enable connection and communication between these components. The second bus system 324 includes a power bus, a control bus, and a status signal bus in addition to a data bus. However, for clarity of illustration, the various buses are designated as second bus system 324.

The second communication interface 323 is used for receiving/transmitting signals in the process of transmitting/receiving information with other external network elements.

The second memory 322 is used for storing a computer program executable on the second processor.

The second processor 321 is configured to determine a first node number of nodes of a current level and a second node number of child nodes corresponding to the nodes of the current level, the first node number and the second node number are used to determine whether to perform RAHT on the nodes of the current level; and determines reconstructed attribute values of the child nodes corresponding to the nodes of the current level according to the first node number and the second node number.

It may be understood that the second memory 322 in the embodiments of the disclosure may be a volatile memory or a non-volatile memory, or may include the volatile memory and the non-volatile memory. The non-volatile memory may be a ROM, a PROM, an EPROM, an EEPROM, or a flash memory. The volatile memory may be an RAM, which is used as an external high-speed cache. By way of example but not restrictive description, many forms of RAMs may be used, for example, an SRAM, a DRAM, an SDRAM, a DDR SDRAM, an ESDRAM, an SLDRAM, and a DR RAM. The second memory 321 of the systems and methods described in this specification includes but is not limited to these and any other proper types of memories.

The second processor 321 may be an integrated circuit chip with signal processing capacity. In an implementation process, various steps of the above method embodiments may be completed by integrated logic circuits of hardware in the second processor 34 or instructions in the form of software. The above second processor 321 may be a general-purpose processor, a DSP, an ASIC, a FPGA, or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software modules may be located in a storage medium mature in the art, such as a random access memory, a flash memory, a read-only memory, a programmable read-only memory or electrically erasable programmable memory, or a register. The storage medium is located in the second memory 322, and the second processor 321 reads information in the second memory 322 and completes the steps in the foregoing methods in combination with hardware of the processor.

It will be appreciated that the embodiments described herein may be implemented in hardware, software, firmware, middleware, microcode or a combination thereof. For the hardware implementation, the processing unit may be implemented in one or more ASICs, DSPs, DSPDs, PLDs, FPGAs, general purpose processors, controllers, microcontrollers, microprocessors, other electronic units or combinations thereof for performing the functions described herein. For software implementations, the technology described herein may be implemented by modules (e.g, procedures, functions, etc.) that perform the functions described herein. The software codes may be stored in memory and executed by a processor. The memory can be implemented in the processor or outside the processor.

An embodiment of the present application provides a decoder. The decoder determines a first node number of nodes of a current level and a second node number of child nodes corresponding to the nodes of the current level, the first node number and the second node number are used to determine whether to perform RAHT on the nodes of the current level; and determines reconstructed attribute values of the child nodes corresponding to the nodes of the current level according to the first node number and the second node number. Thus, in the embodiment of the present application, when predicting the attribute information, the first node number of the nodes of the current level and the second node number of the corresponding child nodes can be obtained first, so that in the process of reconstructing the attribute information of the child nodes corresponding to the nodes of the current level based on the first node number and the second node number, it is possible to determine whether or not the RAHT of the current level is skipped according to the first node number and the second node number, thereby effectively removing the redundancy of attributes, improving the efficiency of the attribute encoding and decoding of the point cloud, and further improving the coding and decoding performance for the point cloud.

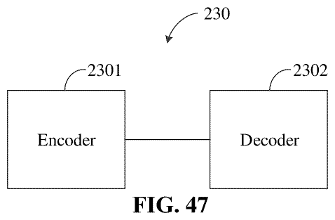

In still another embodiment of the present application, reference is made to FIG. 47, which shows a schematic structure diagram of a codec system provided by the embodiment of the present application. As shown in FIG. 47, the codec system 230 may include an encoder 2301 and a decoder 2302.

In an embodiment of the present application, the encoder 2301 may be the encoder described in any one of the preceding embodiments, and the decoder 2302 may be the decoder described in any one of the preceding embodiments.

In another embodiment of the present application, the embodiment of the present application further provides a bitstream generated by performing bit coding according to information to be coded. The information to be encoded includes at least identification information of the prediction mode and quantized coefficient residuals.

It is to be noted that, in this disclosure, the terms “include”, “comprise” or any other variation thereof, are intended to cover a non-exclusive inclusion, such that a process, method, article, or device that includes a list of elements includes not only those elements but also other elements not expressly listed, or also includes elements inherent to such process, method, article, or device. Without more limitations, an element is defined by the statement “including a . . . ” that does not exclude that there are additional identical elements in a process, method, article, or apparatus that includes the element.

The aforementioned serial numbers of embodiments of the present disclosure are for the purpose of description only and do not represent the advantages or disadvantages of the embodiments.

The methods disclosed in several method embodiments provided in the present disclosure can be arbitrarily combined without conflict to obtain new method embodiments.

The features disclosed in several product embodiments provided in the present disclosure can be arbitrarily combined without conflict to obtain new product embodiments.

The features disclosed in several methods or device embodiments provided in the present disclosure can be arbitrarily combined without conflict to obtain new method embodiments or device embodiments.

The above descriptions are merely specific implementations of the disclosure, but are not intended to limit the scope of protection of the disclosure. Any variation or replacement readily conceived by a person skilled in the art within the technical scope disclosed in the disclosure shall fall within the scope of protection of the disclosure. Therefore, the scope of protection of the disclosure is defined by the scope of protection of the claims.

### INDUSTRIAL PRACTICALITY

Embodiments of the present application provide an encoding method, a decoding method, an encoder, a decoder, a bitstream, and a storage medium. The codec determines a first node number of nodes of a current level and a second node number of child nodes corresponding to the nodes of the current level, the first node number and the second node number are used to determine whether to perform RAHT on the nodes of the current level; and determines reconstructed attribute values of the child nodes corresponding to the nodes of the current level according to the first node number and the second node number. Thus, in the embodiments of the present application, when predicting the attribute information, the first node number of the nodes of the current level and the second node number of the corresponding child nodes can be obtained first, so that in the process of reconstructing the attribute information of the child nodes corresponding to the nodes of the current level based on the first node number and the second node number, it is possible to determine whether or not the RAHT for the current level is skipped according to the first node number and the second node number, thereby effectively removing attribute redundancy, improving the efficiency of encoding and decoding the attribute of the point cloud, and further improving the encoding and decoding performance for the point cloud.

1. A method of decoding, applied to a decoder, comprising:
determining a first node number of nodes of a current level and a second node number of child nodes corresponding to the nodes of the current level, the first node number and the second node number being used to determine whether to perform Region Adaptive Hierarchal Transform (RAHT) on the nodes of the current level; and
determining reconstructed attribute values of the child nodes corresponding to the nodes of the current level according to the first node number and the second node number.

2. The method of claim 1, wherein,
the first node number represents a number of occupied nodes of the current level; and
the second node number represents a number of occupied child nodes or a number of nodes to be decoded in the nodes of the current level.

3. The method of claim 2, wherein determining the reconstructed attribute values of the child nodes corresponding to the nodes of the current level according to the first node number and the second node number comprises:
if the first node number and the second node number are the same, determining reconstructed attribute values of the nodes of the current level as the reconstructed attribute values of the child nodes corresponding to the nodes of the current level.

4. The method of claim 2, wherein determining the reconstructed attribute values of the child nodes corresponding to the nodes of the current level according to the first node number and the second node number comprises:
if the first node number and the second node number are the same, determining a third node number of child nodes in a next level corresponding to the child nodes; and
determining reconstructed attribute values of the child nodes in the next level corresponding to the child nodes according to the second node number and the third node number.

5. The method of claim 2, wherein determining the reconstructed attribute values of the child nodes corresponding to the nodes of the current level according to the first node number and the second node number comprises:
if the first node number and the second node number are different, determining attribute prediction values of the child nodes corresponding to the nodes of the current level according to the nodes of the current level;
performing RAHT based on the attribute prediction values of the child nodes, to determine low-frequency coefficients and reconstructed values of high-frequency coefficients corresponding to the nodes of the current level; and
performing an inverse RAHT based on the low-frequency coefficients and the reconstructed values of the high-frequency coefficients, to determine the reconstructed attribute values of the child nodes.

6. The method of claim 5, wherein determining the attribute prediction values of the child nodes corresponding to the nodes of the current level according to the nodes of the current level comprises:
determining neighboring nodes corresponding to the nodes of the current level; and
determining the attribute prediction values of the child nodes corresponding to the nodes of the current level according to reconstructed attribute values corresponding to the neighboring nodes and an relative distance parameter.

7. The method of claim 5, wherein performing the RAHT based on the attribute prediction values of the child nodes, to determine the low-frequency coefficients and the reconstructed values of the high-frequency coefficients corresponding to the nodes of the current level comprises:
performing the RAHT based on the attribute prediction values of the child nodes, to determine the low-frequency coefficients and prediction values of the high-frequency coefficients corresponding to the nodes of the current level; and
determining the reconstructed values of the high-frequency coefficients corresponding to the nodes of the current level according to the prediction values of the high-frequency coefficients.

8. The method of claim 7, wherein the determining the reconstructed values of the high-frequency coefficients corresponding to the nodes of the current level according to the prediction values of the high-frequency coefficients comprises:
decoding a bitstream to determine quantized coefficient residuals corresponding to the nodes of the current level; and
determining the reconstructed values of the high-frequency coefficients corresponding to the nodes of the current level according to the prediction values of the high-frequency coefficients and the quantized coefficient residuals.

9. The method of claim 8, wherein determining the reconstructed values of the high-frequency coefficients corresponding to the nodes of the current level according to the prediction values of the high-frequency coefficients and the quantized coefficient residuals comprises:
inversely quantizing the quantized coefficient residuals, to determine inversely quantized residuals corresponding to the nodes of the current level; and
determining the reconstructed values of the high-frequency coefficients corresponding to the nodes of the current level according to the inversely quantized residuals corresponding to the nodes of the current level and the prediction values of the high-frequency coefficients corresponding to the nodes of the current level.

10. The method of claim 1, further comprising:
determining geometric information of the nodes of the current level; and
determining the child nodes corresponding to the nodes of the current level and the second node number according to the geometric information.

11. The method of claim 1, wherein,
decoding a bitstream to determine identification information of a prediction mode;
if a value of the identification information of the prediction mode is a first value, determining that a prediction mode corresponding to the nodes of the current level is a preset prediction mode;
if the value of the identification information of the prediction mode is a second value, determining that the prediction mode corresponding to the nodes of the current level is not the preset prediction mode.

12. The method of claim 11, further comprising:
if the prediction mode corresponding to the nodes of the current level is the preset prediction mode, performing a process of determining the first node number and the second node number.

13. A method of encoding, applied to an encoder, comprising:
determining a first node number of nodes of a current level and a second node number of child nodes corresponding to the nodes of the current level, the first node number and the second node number being used to determine whether to perform Region Adaptive Hierarchal Transform (RAHT) on the nodes of the current level; and
determining reconstructed attribute values of the child nodes corresponding to the nodes of the current level according to the first node number and the second node number.

14. The method of claim 13, wherein when the nodes of the current level is at a non-voxel level,
the first node number represents a number of occupied nodes of the current level; and
the second node number represents a number of occupied child nodes or a number of nodes to be encoded in the nodes of the current level.

15. The method of claim 14, wherein determining the reconstructed attribute values of the child nodes corresponding to the nodes of the current level according to the first node number and the second node number comprises:
if the first node number and the second node number are the same, determining reconstructed attribute values of the nodes of the current level as the reconstructed attribute values of the child nodes corresponding to the nodes of the current level.

16. The method of claim 14, wherein determining the reconstructed attribute values of the child nodes corresponding to the nodes of the current level according to the first node number and the second node number comprises:
if the first node number and the second node number are the same, determining a third node number of child nodes in a next level corresponding to the child nodes; and
determining reconstructed attribute values of the child nodes of the next level corresponding to the child nodes according to the second node number and the third node number.

17. The method of claim 14, wherein determining the reconstructed attribute values of the child nodes corresponding to the nodes of the current level according to the first node number and the second node number comprises:
if the first node number and the second node number are different, determining attribute prediction values of the child nodes corresponding to the nodes of the current level according to the nodes of the current level;
performing RAHT based on the attribute prediction values of the child nodes and the attribute value of the child nodes, respectively, to determine reconstructed values of high-frequency coefficients and low-frequency coefficients corresponding to the nodes of the current level; and
performing an inverse RAHT based on the low-frequency coefficients and the reconstructed value of the high-frequency coefficients, to determine the reconstructed attribute values of the child nodes.

18. The method of claim 17, wherein determining the attribute prediction values of the child nodes corresponding to the nodes of the current level according to the nodes of the current level comprises:
determining neighboring nodes corresponding to the nodes of the current level; and
determining the attribute prediction values of the child nodes corresponding to the nodes of the current level according to reconstructed attribute values corresponding to the neighboring nodes and an relative distance parameter.

19. The method of claim 17, wherein performing the RAHT based on the attribute prediction values of the child nodes and the attribute values of the child node, respectively, to determine the reconstructed values of the high-frequency coefficients and the low-frequency coefficients corresponding to the nodes of the current level comprises:
performing the RAHT based on the attribute prediction values of the child nodes, to determine the low-frequency coefficients and prediction values of the high-frequency coefficients corresponding to the nodes of the current level;
performing the RAHT based on the attribute values of the child nodes, to determine the low-frequency coefficients and the high-frequency coefficients corresponding to nodes of the current level; and
determining the reconstructed values of the high-frequency coefficients corresponding to the nodes of the current level according to the prediction values of the high-frequency coefficients corresponding to the nodes of the current level and the high-frequency coefficients corresponding to the nodes of the current level.

20. A non-transitory computer-readable storage medium, having a computer program and a bitstream stored thereon, wherein the computer program, when executed by a processor, enables the processor to perform the following operations to generate the bitstream:
determining a first node number of nodes of a current level and a second node number of child nodes corresponding to the nodes of the current level, the first node number and the second node number being used to determine whether to perform Region Adaptive Hierarchal Transform (RAHT) on the nodes of the current level; and
determining reconstructed attribute values of the child nodes corresponding to the nodes of the current level according to the first node number and the second node number.
